(19) United States
(12) Patent Application Publication
(10) Pub. No.: US 2024/0279929 A1
(43) Pub. Date: Aug. 22, 2024

(54) Grout to Grout Rebar Connector

(71) Applicant: ERICO International Corporation, Solon, OH (US)

(72) Inventors: Steven McDaniel, Burton, OH (US); Anirudha Vaidya, Solon, OH (US); Samuel Barker, Solon, OH (US)

(21) Appl. No.: 18/583,146

(22) Filed: Feb. 21, 2024

Related U.S. Application Data
(60) Provisional application No. 63/486,381, filed on Feb. 22, 2023.
(60) Provisional application No. 63/511,767, filed on Jul. 3, 2023.

(51) Int. Cl. E04C 5/16; E04G 21/12

(52) U.S. Cl. CPC E04C 5/165; E04G 21/12

(57) ABSTRACT

A rebar coupler can have a coupler body with a hollow interior, and a first end and a second end that are open to the hollow interior to receive rebar into opposing ends of the hollow interior along a longitudinal axis. One or more grout ports can be included on the coupler body, including a first grout port on the first end of the coupler body. The coupler body can include a set screw, a removable stop, a narrowed first end, a removable cap, or other features.

### CROSS-REFERENCE TO RELATED APPLICATIONS

This application claims priority to U.S. provisional patent application No. 63/486,381, filed Feb. 22, 2023, and U.S. provisional patent application No. 63/511,767, filed Jul. 3, 2023, the entireties of which are incorporated herein by reference.

### BACKGROUND

Concrete is a mixture of cement, water, and aggregates. Known for its strength, durability, low maintenance, energy efficiency, and relatively low cost, concrete is one of the most frequently used building materials used for constructing buildings, bridges, roads, sidewalks and other structures. In some structures, concrete is used in combination with reinforcement bars (herein, rebars). The combination of concrete and rebars is known as reinforced concrete and is widely used to mitigate the weak tension of concrete by distributing the tensile forces evenly across the structure and support heavy loads.

### SUMMARY

Some examples of the disclosed technology provide a rebar connector having a coupler body with a hollow interior, and a first end and a second end that are open to the hollow interior to receive rebar into opposing ends of the hollow interior along a longitudinal axis. One or more grout ports can be included on the coupler body, including a first grout port on the first end of the coupler body.

In some examples, a threaded hole can be arranged on the coupler body to receive a set screw to secure rebar within the hollow interior. A set of pads can be arranged within the hollow interior to collectively align and support rebar engaged by the set screw, the set of pads including at least one first pad arranged between the threaded hole and the first end of the coupler body and at least one second pad arranged between the threaded hole and the second end of the coupler body.

In some examples, a first removable end cap can engage an outer diameter of the first end of the coupler body and extend around rebar received into the first end to close the first end.

In some examples, the rebar connector can include a removable pin or other removable stop to provide an internal stop for rebar received into either of the first or second ends.

In some examples, the first end of the coupler body can include a first opening to receive rebar into the hollow interior. The first opening can be smaller than a second opening on the second end to receive rebar into the hollow interior.

Some examples of the disclosed technology provide a method of securing concrete components together. A first concrete component can be provided, with an embedded coupler body (e.g., as described above or below). A second concrete component can be aligned, to extend rebar from the second concrete component into the embedded coupler body. Grout can be introduced (e.g., injected or poured) into the hollow interior of the embedded coupler body.

Some examples of the disclosed technology provide a method of preparing a prefabricated concrete component. A rebar connector (e.g., as described above or below) can be provided. The concrete component can be cast with the rebar connector embedded therein.

In some examples of the disclosed technology provide a rebar connector that includes a coupler body and one or more grout ports. The coupler body can have a hollow interior, and a first end and a second end that are open to the hollow interior to receive rebar into opposing ends of the hollow interior along a longitudinal axis. The one or more grout ports can include a first grout port on the first end of the coupler body.

In some examples, the hollow interior can define a plurality of cells to engage grout received within the coupler body, including an end cell adjacent to the first grout port that is one or more of axially longer than an adjacent cell or radially wider than an adjacent cell.

In some examples, the first grout port one or more of: extends at an oblique angle relative to an axial direction of the coupler body; or supports an outlet tube that one or more of: extends at an oblique angle relative to the axial direction, or is bent relative to the axial direction.

Some examples of the disclosed technology provide a stop assembly for prefabricated concrete construction. The stop assembly can include a fastener, an anchor (e.g., an expandable anchor), and a stop body. The fastener can be configured to be secured to a concrete form. The anchor can be supported by the fastener. The stop body can extend from the anchor or the fastener. The fastener can be configured to be tightened to secure the anchor to a rebar connector, with the stop body supported within the rebar connector to provide a stop for rebar inserted into the rebar connector.

Some examples of the disclosed technology provide a method of prefabricating a concrete structure. A first end of a rebar connector can be secured to a concrete form with a stop assembly, so that a stop body of the stop assembly extends within the rebar connector. A length of rebar can be inserted into a second end of the rebar connector until the rebar contacts the stop body. Concrete can be cured around the rebar and the rebar connector. The stop assembly and the concrete form can be removed from the rebar connector and the cured concrete.

Some examples of the disclosed technology provide a coupler system for rebar that includes a rebar coupler having a coupler body. The coupler body includes a hollow interior and a first end and a second end that are open to the hollow interior to receive rebar into opposing ends of the hollow interior along a longitudinal axis. The coupler defines one or more grout ports that open into the hollow interior including a first grout port on the first end of the coupler body. The hollow interior includes internal ribs that defines cells to engage grout received within the coupler body. The cells include a first cell adjacent to the first grout port and defines a first volume to receive grout and a second cell adjacent to the first cell and defines a second volume to receive grout. The first cell is radially wider than the second cell so that the first volume is larger than the second volume.

In some examples, the disclosed technology provide a coupler system for rebar that includes a rebar connection having a coupler body with a hollow interior and one or more grout ports that open into the hollow interior including a first grout port. The hollow interior defines cells to engage grout received within the coupler body. The cells including a first cell that defines a first volume to receive grout and a second cell that is adjacent to the first cell and defines a second volume to receive grout. The first grout port opening into the first cell and the first volume being larger than the second volume.

Some examples of the disclosed technology provide a method of prefabricating a concrete structure using a coupler system for rebar that includes securing a rebar connector to a concrete form with a stop assembly such that a first end of a coupler body of the rebar connector extends away from the concrete form, an anchor of the stop assembly is secured to a concrete form and engages a second end of the coupler body to secure the stop assembly to the coupler body, and a stop body of the stop assembly is supported within a hollow interior of the coupler body to provide a stop for the first length of rebar within the hollow interior, inserting a first length of rebar into the hollow interior via the first end of the rebar connector until the first length of rebar contacts the stop body, pouring and curing concrete around the first length of rebar and the rebar connector, and removing the stop assembly and the concrete form from the rebar connector and the cured concrete.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIG. 1 is an axonometric view of a rebar connector configured as a grout-to-grout coupler, including a first section of rebar and a second section of rebar according to an example of the disclosed technology;

FIG. 2 is a cross-sectional view of the grout-to-grout coupler of FIG. 1;

FIGS. 3 and 4 are side elevation and axonometric cross-sectional views of the grout-to-grout coupler of FIG. 1;

FIG. 5 is an axonometric view of a grout-to-grout coupler including a first section of rebar, a second section of a rebar and a cap according to another example of the disclosed technology;

FIG. 6 is a top plan view of the grout-to-grout coupler of FIG. 5;

FIGS. 7A-7C are axonometric views of different configurations of the cap of FIG. 5;

FIG. 8 is an axonometric view of the cap and a first end of the grout-to-grout coupler of FIG. 5;

FIGS. 9A-9C are axonometric views of a method of assembling one configuration of the cap with the grout-to-grout coupler of FIG. 5;

FIGS. 10A-10C are axonometric views of a method assembling another configuration of the cap with the grout-to-grout coupler of FIG. 5; and

FIGS. 11A-11C are axonometric views of the further aspects of example configurations of the cap.

FIG. 12A is a cross-sectional view of the grout-to-grout coupler of FIG. 1 in a final vertical position, with grout pumped into a coupler cavity of the coupler;

FIG. 12B is a cross-sectional view of the grout-to-grout coupler of FIG. 1 in the final vertical position, showing grout volume loss via off-gassing;

FIGS. 13A and 13B are cross-sectional views of a grout-to-grout coupler including a lengthened cell along an upper end;

FIGS. 14A and 14B are cross-sectional views of a grout-to-grout coupler including a widened cell along the upper end;

FIGS. 15A and 15B are cross-sectional views of a grout-to-grout coupler including an angled port according to another example of the disclosed technology;

FIG. 16 is an axonometric view of another grout-to-grout coupler according to an example of the disclosed technology;

FIG. 17 is a cross-sectional view of the grout-to-grout coupler of FIG. 16;

FIG. 18 is a cross-sectional view of the grout-to-grout coupler of FIG. 16 including a first section of rebar and a reusable stop assembly according to an example of the disclosed technology;

FIG. 19 is an axonometric view of an elongated stop of the stop assembly of FIG. 18;

FIGS. 20-21 are partial cross-sectional views of the grout-to-grout coupler of FIG. 16 including a first section of rebar and the reusable stop assembly of FIG. 18 with various fastening mechanisms;

FIG. 22 is an isometric view of another grout-to-grout coupler according to an example of the disclosed technology;

FIG. 23 is a cross-sectional view of the grout-to-grout coupler taken along line 23-23 of FIG. 22, with a cap detached from the coupler;

FIG. 24 is a cross-sectional view of the grout-to-grout coupler taken along line 24-24 of FIG. 22;

FIG. 25 is an isometric view of the grout-to-grout coupler of FIG. 22 secured to a concrete form with another reusable stop assembly;

FIG. 26 is a cross-sectional view of the grout-to-grout coupler secured to the concrete form taken along line 26-26 of FIG. 25;

FIG. 27 is an isometric view of another grout-to-grout coupler according to another example of the disclosed technology;

FIG. 28 is a cross-sectional view of the grout-to-grout coupler taken along line 28-28 of FIG. 27, with a cap detached from the coupler; and

FIG. 29 is a cross-sectional view of the grout-to grout coupler of FIG. 27, secured to the concrete form with a reusable stop assembly.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other examples and of being practiced or of being carried out in various ways.

The following discussion is presented to enable a person skilled in the art to make and use examples of the disclosed technology. Various modifications to the illustrated examples will be readily apparent to those skilled in the art, and the generic principles herein can be applied to other examples and applications without departing from examples of the disclosed technology. Thus, examples of the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives and fall within the scope of examples of the disclosed technology.

In some construction operations, reinforced concrete is pre-cast at a prefabrication site (e.g., a dedicated facility) to form a section of a structure (e.g., walls or columns). Various sections can then be transported to an installation site to be joined together into a larger assembled structure, typically with various rebar connectors used to join the rebar of adjacent sections of the concrete.

In some examples, ends of rebar in adjacent structures (or otherwise arranged) can be joined together with couplers, including couplers that receive grout to secure the rebar therein. Examples of the disclosed technology can provide improved couplers for such grout-based couplings, including as can allow for easier staging of rebar for prefabrication or other operations, improved flexibility in installation and prefabrication, and reduced use of grout overall. For example, some couplers can include set screws with corresponding pads to stage rebar for prefabrication (or otherwise) and potentially carry a substantial portion of axial loading. In some examples, some couplers can have a narrower end to reduce grout usage and improve prefabrication operations, can include improved cap structures, can include a removable stop (e.g., roll pin, tapered or other solid pin, or other elongate body), or various other improvements. Improved caps for couplers are also presented, including as can allow for optimized placement of grout ports and for flexibility in pre-fabrication procedures.

In some examples, couplers can have various end features (e.g., with enlarged internal geometry) to reduce potential detrimental effects of off-gassing of grout, improve overall strength, or provide various other improvements. In some examples, couplers can be installed with a reusable internal rebar stop to both secure the couplers to concrete forms and prevent over-insertion of rebar into the coupler during prefabrication (or during on-site operations).

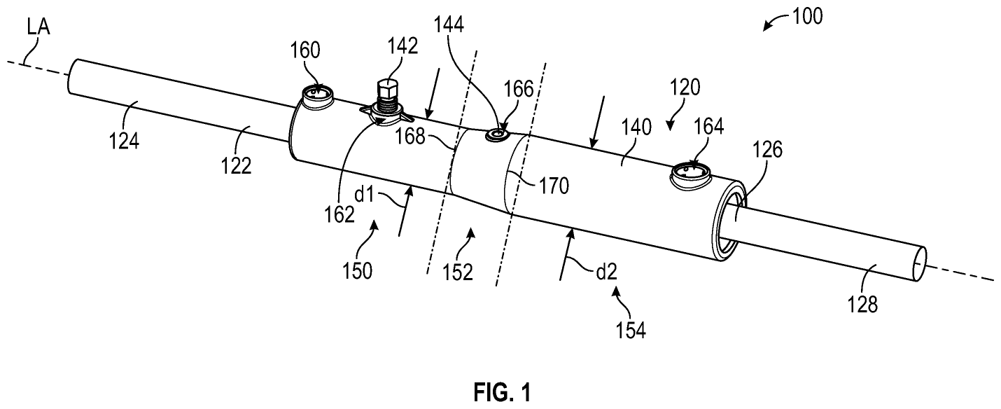

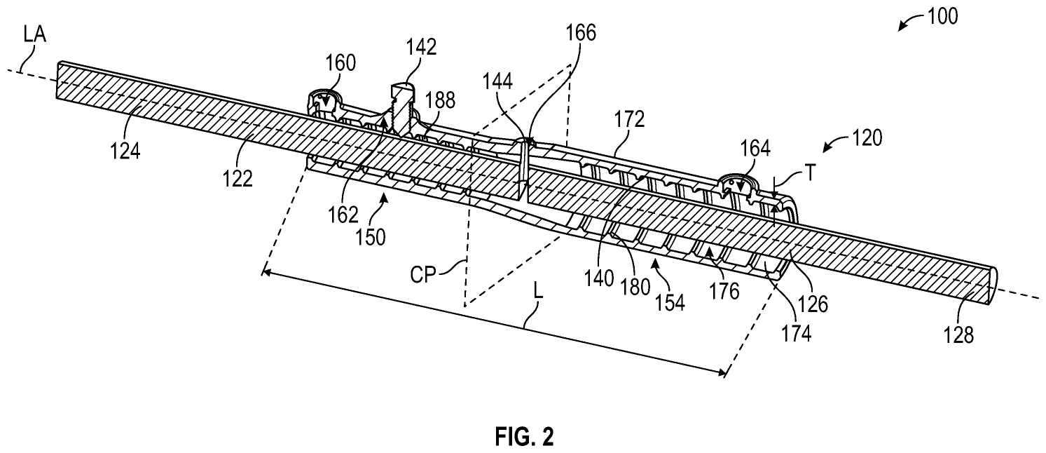

FIG. 1 illustrates a rebar connector assembly 100 including a grout-to-grout rebar coupler 120, a first section 122 of a first rebar 124, a second section 126 of a second rebar 128. The coupler 120 includes a body 140, and a set screw 142 secured in a threaded hole to extend into the interior of the body 140 (see FIG. 2). A stop 144 for the rebar 124, 128 (e.g., a roll pin, as shown in FIG. 2) can also extend into the interior of the body. In some cases, as further discussed below, such a stop can be selectively insertable or may be removable.

The body 140 of the coupler 120 may be a hollow tube shape, including with a generally circular cross-sectional profile, as shown. In particular, the body includes a first end 150, a second end 154 opposite of the first end 150, and a medial region 152 disposed between the first end 150 and the second end 154. The first end 150 includes a first grout port 160 and a hole 162 that receives the set screw 142. The second end 154 includes a second grout port 164. The medial region 152 includes an aperture 166 that receives the stop 144.

As also discussed below, some examples may not include the aperture 166, or may otherwise vary from the particular example illustrated in FIG. 1. Further, in some examples, the body 140 may include a plurality of holes (not shown) disposed between the first grout port 160 and a second grout port 164 (e.g., along a longitudinal axis) to receive multiple set screws. For example, in some configurations, the body 140 may include a plurality of holes disposed between the first grout port 160 and a second grout port 164 along the longitudinal axis LA. Multiple set screws can be inserted into the plurality of holes to fix the rebar 124, 128 within the coupler 120. For example, the multiple set screws can be disposed in a linear pattern (e.g., in a parallel line) along the longitudinal axis LA.

The first and second grout port 160, 164 are ports that can be selectively used to pump in the grout at either end of the body 140. Different locations are possible for grout ports, among other variations (e.g., number, size, shape, etc.), in different examples. However, it may be useful in some cases to locate at least one port (e.g., the port 160, as shown) as close to a free end of a coupler as possible (e.g., within one or two port diameters of the free end). This arrangement, for example, can allow a coupler to more conveniently accommodate a cross-tie connection to other couplers during prefabrication, among other benefits.

Continuing with respect to the present example configuration, the first end 150 of the body 140 defines a first diameter d1 and the second end 154 of the body defines a second diameter d2. In some examples, the first diameter d1 is different from the second diameter d2 (e.g., smaller, as shown). In some cases, including as shown, an end with a hole to receive a set screw (e.g., the first end 150, as shown) 142 may have a smaller diameter than an opposing end (e.g., the second end 154, as shown).

In different examples, different transitional profiles may extend between opposing ends of a coupler. For example, the medial region 152 includes a first surface 168 with the same diameter as the first diameter d1 and a second surface 170 with the same diameter as the second diameter d2. A central area of the medial region 152 is tapered to provide a gradual transition between the first diameter d1 and the second diameter d2. In the illustrated example, the medial region 152 includes a constant-slope linear taper. Alternatively, a medial region may include different configurations. In some examples, the medial region 152 can be straight without being tapered, i.e., may extend at a constant diameter. In some examples, the medial region 152 may be curved. For example, the medial region 152 may taper along an S-shaped profile to transition between the first and second diameter.

The first end 150 having a narrower first diameter d1 than the second diameter d2 of the second end 154 can provide various benefits, including reduction of the amount of grout needed to be pumped into the coupler 120 through the first or second grout port 160, 164, and larger assembly tolerance when inserting the second section 126 of the second rebar 128 (e.g., during on-site assembly of separate concrete sections). In this latter regard, for example, it may be easier to couple prefabricated components together by inserting rebar into wider the second end 154, in addition to various other benefits as further discussed below (e.g., use of the set screw 142 to stage the rebar 124 during prefabrication).

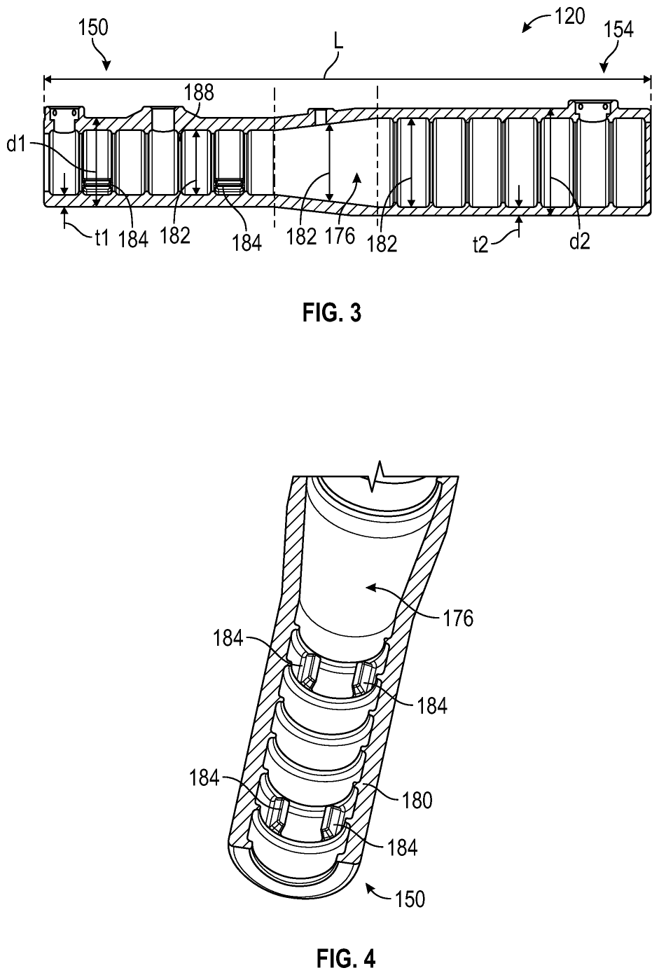

Referring now to FIGS. 2 and 3, the rebar connector assembly 100 of FIG. 1 is shown in a cross-sectional view to illustrate how different components of the assembly 100 interact with one another within the hollow interior (and otherwise). The body 140 includes an outer surface 172, a thickness T defined between the outer surface 172 and an inner surface 174 opposite of the outer surface 172. The inner surface 174 (including various ribs or other protrusions) circumferentially defines a hollow internal volume 176 of the body 140 about a longitudinal axis LA.

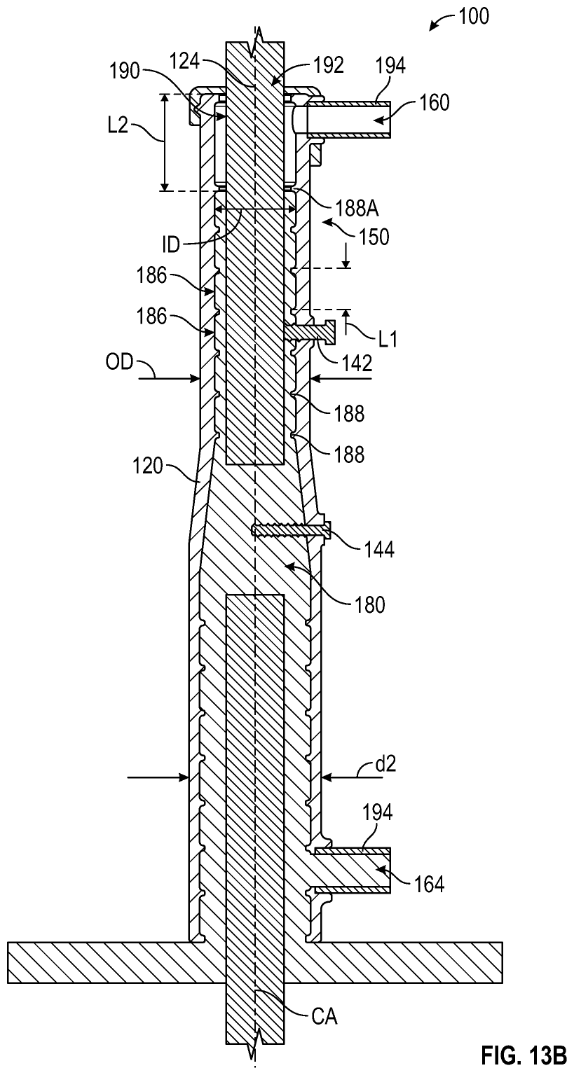

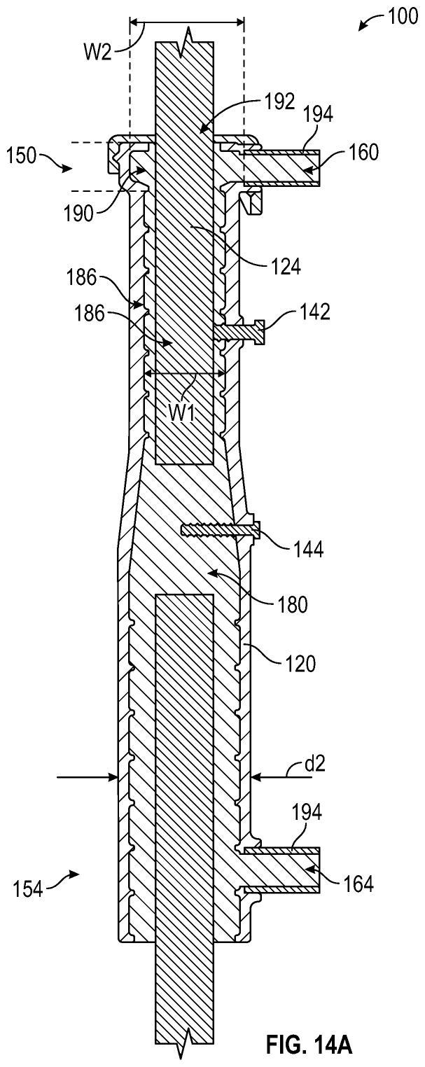

In the illustrated example, the inner surface 174 includes ribs 188 (see also FIG. 13A) extending diametrically around the inner surface 174. The ribs 188 can provide increased surface area for the cured grout to grip onto after being pumped in through the first or the second grout port 160, 164. In some examples, the ribs 188 may also provide assistance to align the first and second rebars 124, 128 along the longitudinal axis LA.

The stop 144 received by the aperture 166 disposed within the medial region 152 can provide a stop against over-insertion of the rebar 124, 128, and separate the rebar 124, 128 across a central plane CP that is orthogonal to the longitudinal axis LA. In some examples, the stop 144 or another similar stop can be inserted as desired, including after rebar has been inserted into the coupler 120 during a prefabrication operation (e.g., as further discussed below).

With the rebar inserted, the set screw 142 can be tightened in the hole 162 to clamp the first rebar 124 in alignment with the longitudinal axis at a pre-determined location. The pre-determined location, for example, can be further defined by the stop 144, and can in some cases be at optimized locations on the rebar along a length L of the body 140 of the coupler 120 (e.g., for loading, access, or other factors). In some cases, the set screw 142 can provide a sufficiently strong connection as to appreciably increase the axial load rating of the coupler 120 (e.g., by 25% or more) as opposed to a similar design without a set screw. In other words, as well as helping to stage the rebar 124 and the coupler 120 during prefabrication, the set screw 142 can significantly supplement the grout to provide axial load strength in a final assembly.

Of note, the thickness T as discussed above can be variable in some cases. For example, in the illustrated configuration, the body 140 has a larger thickness T at the first end 150 than at the second end 154. For example, the thickness T can be sufficiently larger at the first end 150 such that a cross sectional area at a location along the first end 150 is substantially equal to cross sectional area at a location along the second end 154, with corresponding substantial uniformity of stress values at the respective locations, for a given axial loading. As shown in FIG. 3, in particular, the first end 150 defines a first thickness t1 and the second end defines a second thickness t2. The first thickness t1 is thicker than the second thickness t2, as also corresponds to the varied inner diameter 182 of the coupler 120. Thus, different diameter rebar can be inserted into the first and second end 150, 154, respectively, or more generally the coupler 120 can provide increased clearance for insertion of rebar into the second end 154, without significant increase in required grout volume or loss of coupler strength.

In some configurations, guide protrusions can be arranged internally to a coupler, relative to a set screw location, to assist in aligning and securing rebar in a coupler (e.g., to stage the rebar and the coupler during prefabrication operations). Referring now to FIGS. 3 and 4, for example, the first end 150 of the coupler 120 includes pads 184 to orient and help secure the first section 122 of the first rebar 124, when the set screw 142 is tightened within the internal volume 176 of the coupler 120. In particular, the pads 184 extend between adjacent sets of the ribs 188, although other configurations are possible. Further, in the illustrated example, the pads are arranged on opposing sides of the set screw 142 (relative to the longitudinal axis LA), so that at least one pad is arranged between the set screw 142 and the first end 150 of the coupler body 140, and at least one pad is arranged between the set screw 142 and the second end 154 of the coupler body 140. In particular, as shown in FIG. 4, two pads 184 can extend toward each respective end 150, 154, with the pads 184 of each set spaced circumferentially from each other. Further, to provide improved contact with the varied diameter of rebar, the pads 184 are formed as protruding ribs that extend in an elongate direction (e.g., in parallel with the longitudinal axis LA). In other examples, however, other geometries are also possible.

The plurality of pads 184 can thus enable the first rebar 124 to be appropriately constrained relative to six degrees of freedom, as the set screw 142 pushes the first rebar 124 down toward the plurality of pads 184 to locate the body 140 in relation to the first section 122 of the first rebar 124. In this regard, for example, the pads 184 and the set screw 142 can constrain rotational movement as well as axial movement between the body 140 and the first rebar 124.

In some examples, the set screw 142 may share the tension load with the cured grout that fills the internal volume 176 of the first end 150, including so as to notably increase axial load rating of the coupler (i.e., in combination with the grout). Such an increase could, for example, enable a length of the first portion 150 to be shorter than a length the second portion 154, because the set screw 142 sharing the tension load allows for the use of less surface area at the end 150 for grout engagement. For example, reduction in length of 25% or more may be possible, as compared to equivalent systems without such a set crew arrangement.

In some examples, the stop 144 can be removed from the body 140 of the coupler 120, or not initially inserted, to allow a user to slide rebar through an entirety of the coupler 120 during the assembly process. Thus, for example, prefabrication processes may not necessarily be constrained by limitations on inserting rebar fully through couplers, as with some conventional designs (e.g., with integral stops). However, the assistance of a stop can still be employed for final positioning, as the stop 144 can be readily inserted into the coupler 120 at the appropriate process step.

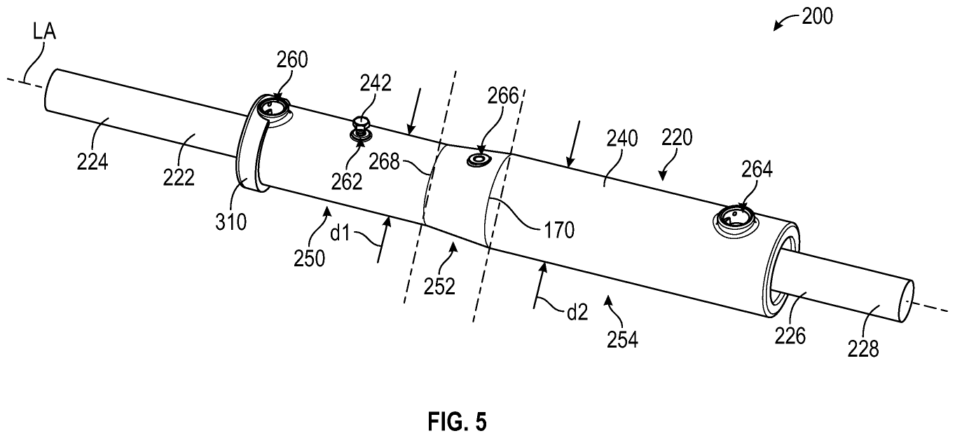

FIG. 5 illustrates a different example of a rebar connector assembly 200 including a cap 310 that can close (e.g., seal) an end of the connector assembly 200 against leakage of grout or unset concrete. The rebar connector assembly 200 provides an alternate configuration of the rebar connector assembly 100 described above. In this regard discussion of the connector assembly 100 above generally also applies to the connector assembly 200, and similar numbering in the 200 series is used for the rebar connector assembly 200. For example, the rebar connector assembly 200 includes a grout-to-grout rebar coupler 220, a first section 222 of a first rebar 224, and a second section 226 of a second rebar 228, etc. However, the addition of the cap 310 can help grout to be contained within the internal volume of the body 240, or keep the concrete from entering the body 240 during pre-fabrication.

Generally, the cap 310 can be made from suitable elastomers (e.g., rubber, silicone, etc.), so as to be resiliently secured to the coupler 220 and resiliently surround (e.g., seal around) rebar received into the coupler 220. In particular, and as further discussed below, the cap 310 can engage an exterior of the coupler 220 to secure the cap 310 thereto, with various corresponding benefits. In particular, the cap 310 is shown at the first end 250 to surround the first diameter d1, although other examples can be secured at the second end 254 to surround the second diameter d2.

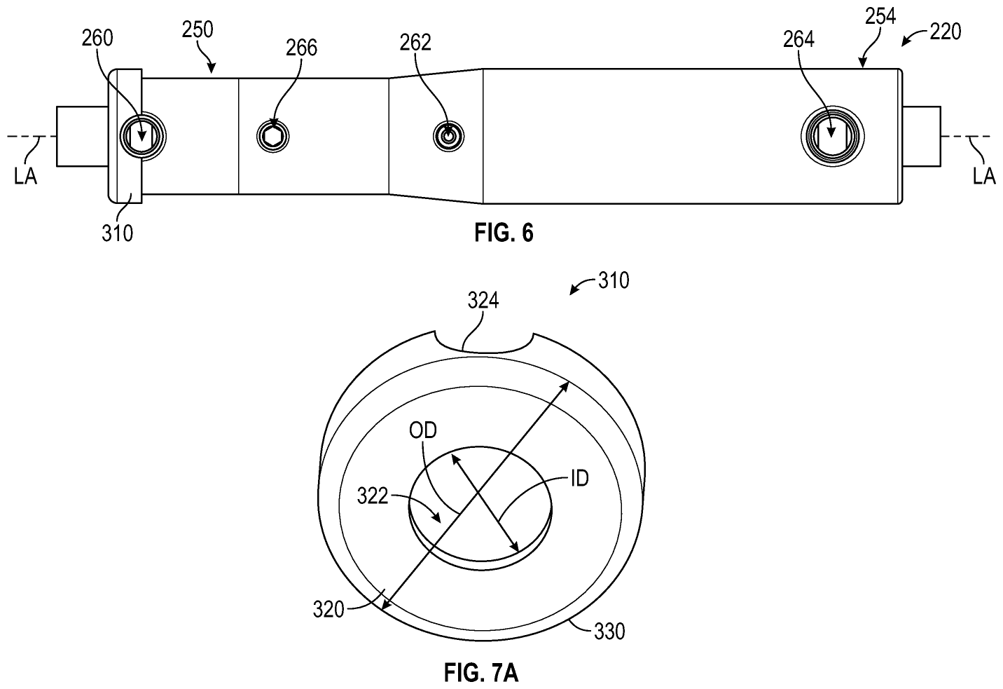

As shown in FIG. 6, in particular, the cap 310 can include a cut-out arranged to receive the structure of the grout port 260. In this regard, the disclosed cap configuration can accommodate optimal locations of grout ports while also allowing the continued use of sealing caps. For example, engagement of a cap with the outer diameter of a coupler, as opposed to an inner diameter, can allow a cap to include an appropriate cut-out with relatively little loss of structural integrity. Thus, examples of the disclosed caps can be modified to avoid ports that may be optimally located as close as possible to a free end of a coupler (e.g., to accommodate cross-ties during pre-fabrication), without losing the ability to reliably close (or seal) the coupler. Further, exterior engagement (e.g., as shown) can help to avoid the risk of the cap being displaced to block a grout port (e.g., if the cap is seated on rebar and the rebar is then pushed into the coupler, during pre-fabrication operations).

As also shown in FIG. 6, the outer diameter of the cap 310 can be equal to or less than the second diameter d2 of the coupler 220. In other words, because the first end 250 exhibits a reduced diameter, attaching the cap 310 to the outer diameter of the coupler 220 at the first end 250 does not necessarily increase the overall diametric (projected) footprint of the coupler assembly. Thus, for example, the cap 310 surrounding the outer diameter of the first end 250 may not negatively influence clearance or required tolerances for assembly processes. Accordingly, including the cap 310 may not generally reduce a clearance between the coupler 220 and the surrounding structures, such as might negatively impact a pre-fabrication assembly process. In some examples, however, the cap 310 can be used at the thicker end of a coupler (e.g., second end 254), as also noted above.

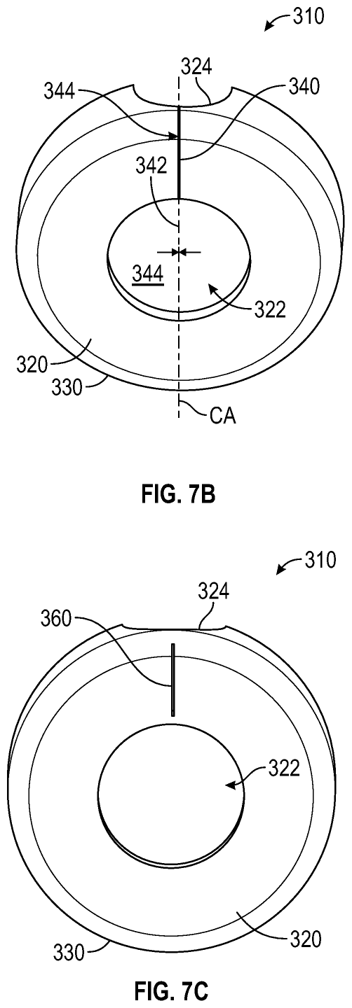

FIGS. 7A-7C illustrate different configuration of caps 310 that can be used with the coupler 220. Referring to FIGS. 6 and 7A, the cap 310 generally defines a cap surface 320, a central aperture 322, and a cutout 324 (as needed). The cap surface 320 includes an outer periphery 330 that defines an outer diameter OD and the central aperture 322 defining an inner diameter ID. Referring to FIG. 7B the central aperture 322 can include a full slit 340 that is connected with the cutout 324. The full slit 340 can thus separate the cap 310 about a central axis CA, defining two ends 342 directly opposite of each other separated by a gap 344 that can be resiliently bent in various (e.g. opposing) directions. Referring to FIG. 7C, a partial slit 360 can similarly extend partially between the cutout 324 and the central aperture 322. The partial slit 360 can provide the end user the flexibility of breaking the partial slit 360 to form the full slit 340 of the cap 310 shown in FIG. 7B, or using the cap 310 without breaking the slit 360 (as shown in FIG. 7C).

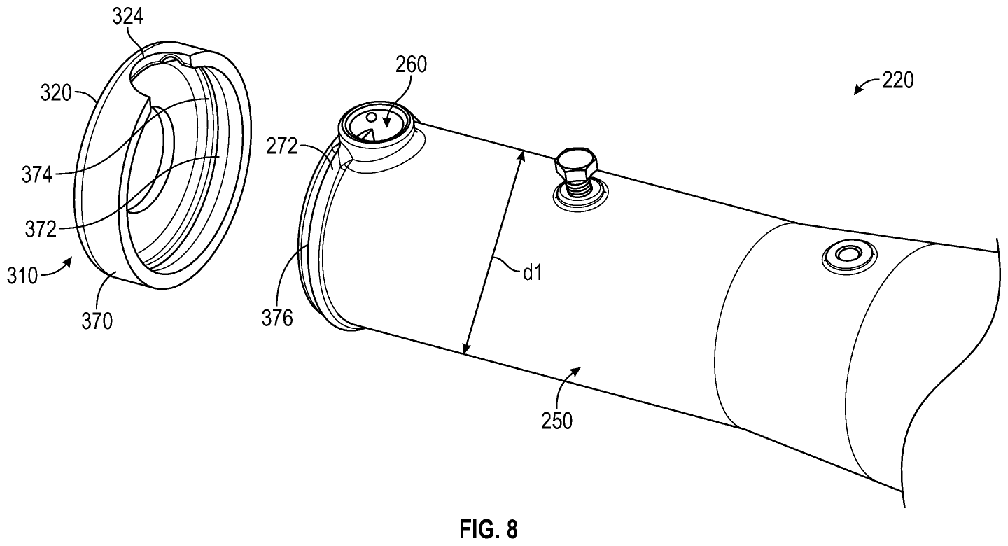

In different examples, different structures can be used to secure a cap to an exterior of a coupler. For example, as shown in FIG. 8 the cap 310 has a side wall 370 that extends from the cap surface 320 and includes an elastomer rib 372 that revolves diametrically around an inner surface 374 of the side wall 370. Further, the first end 250 of the coupler 220 includes a mating rib 376 that revolves diametrically around the outer surface 272 defined by the first diameter d1 of the coupler 220 (e.g., adjacent to the first grout port 260). The side wall 370 of the cap 310 can accordingly be stretched to fit around the outer diameter of the first end 250 defined by the first diameter d1, so that the elastomer rib 372 engages the mating rib 376 of the first end 250 to secure the cap 310 in place. Thus arranged, the cap 310 can be securely attached, including with the cutout 324 partially surrounding the first grout port 260, as needed (as also discussed above).

Conventionally, a cap for a coupler is first applied to the inner diameter of the coupler and the rebar is then inserted through both the seal and the coupler. However, because the seal adds friction and can be restricted in flexibility by the boundary of the inner diameter of the coupler, it can be difficult to insert the rebar through both the seal and the coupler. For example, because the outer diameter of that seal is fixed in place against the inner diameter of the coupler, the flexing of the seal can be overly restricted, and the inner diameter of the seal thus cannot easily flex to admit the rebar. In contrast, because it is secured around the outer diameter of the coupler 220, the cap 310 can provide a more flexible connection with rebar, with corresponding improved flexibility in the order of assembly, among other benefits.

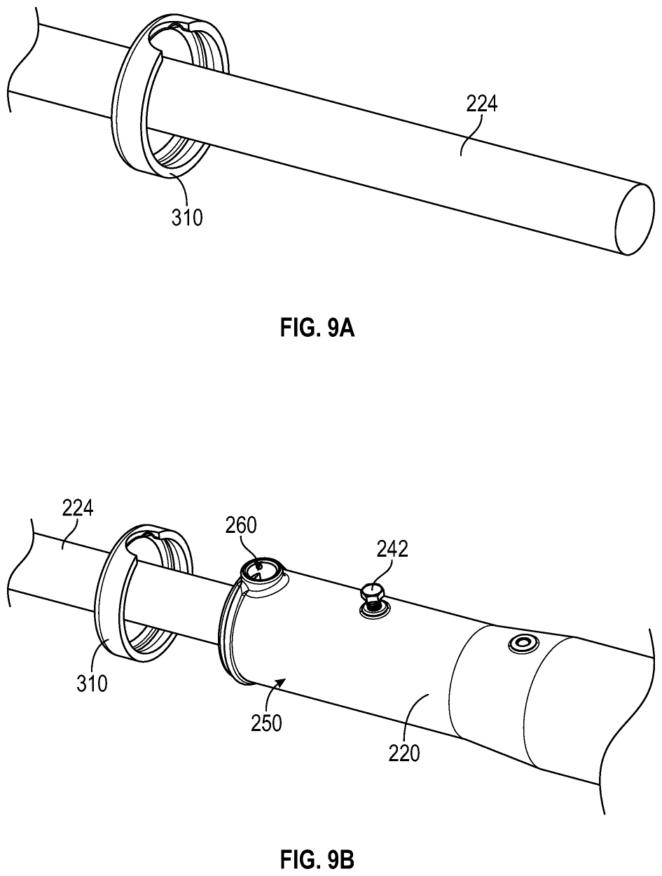

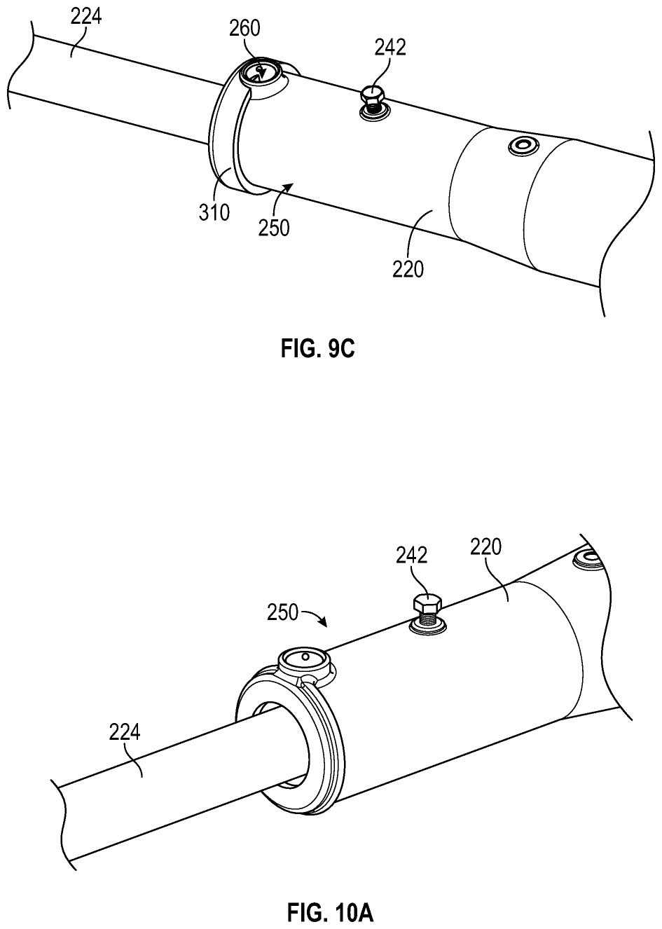

In this regard, referring to FIGS. 9A-9C, an example order of assembly for the cap 310 with the coupler 220 is shown. Referring to FIG. 9A, prior to coupling with the coupler 220, the cap 310 can be inserted over first rebar 224. Referring to FIG. 9B, the first rebar 224 can then be inserted into the coupler 220 from the first end 250. Referring to FIG. 9C, the set screw 242 can then be tightened and the cap 310 can be slid down the first rebar 224 to be secured around the outer diameter of the first end 250 (in any order desired). As mentioned above, the outer diameter OD of the cap 310 (see, e.g., FIG. 7A) is thus not restricted by coupler 220 as in conventional assemblies, and the inner diameter ID of the cap 310 (see, e.g., FIG. 7A) can easily flex to allow the cap 310 to move along the first rebar 224.

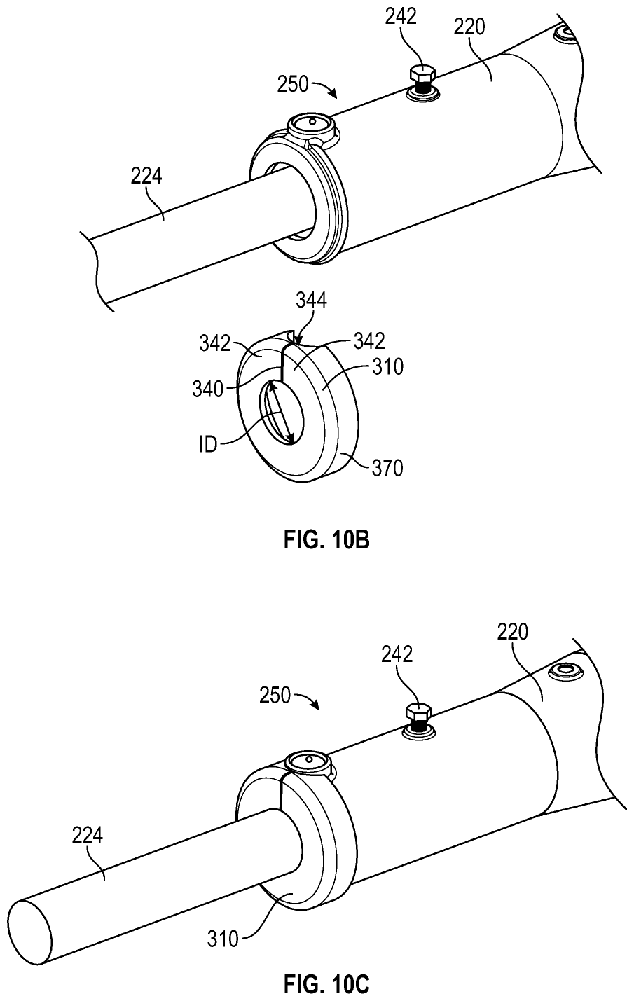

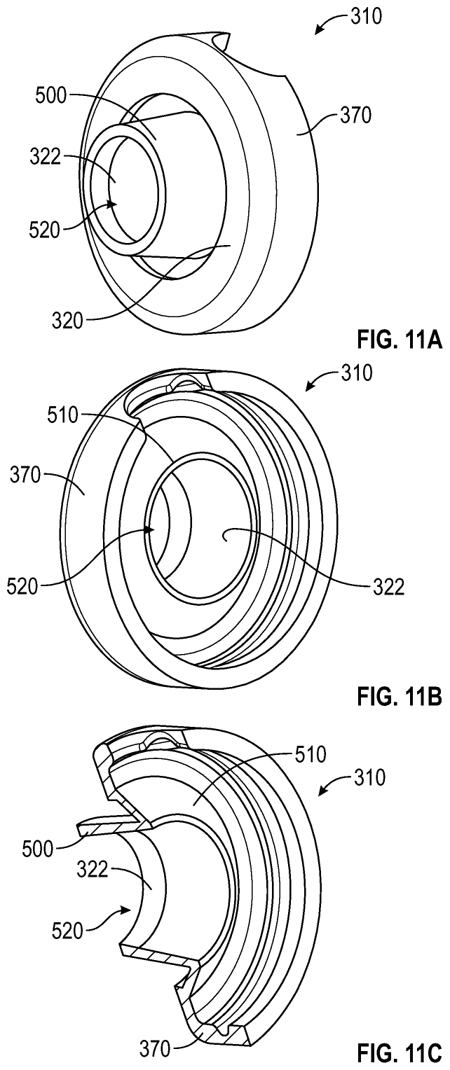

As mentioned above, a different order of assembly between the cap 310 and the coupler 220 is also possible. For example, referring to FIGS. 10A-10C, the cap 310 with the full slit 340 (see also FIG. 7B) can be installed after rebar is installed into the coupler 220. Referring to FIG. 10A, the first rebar 224 can be inserted to the first end 250 of the coupler 220 and the set screw 242 can be tightened. The cap 310 can then be aligned as shown in FIG. 10B, and the two ends 342 of the full slit 340 can be distorted (e.g., stretched or twisted) to increase the gap 344 and thereby fit the cap 310 around the first rebar 224. Due to the elasticity of the elastomeric material forming the cap 310, the two ends 342 can return back toward the original shape once installed around the rebar 224, and thus retain the cap 310 on the rebar 224. The cap 310 can then be slid along the first rebar 224 so that the side wall 370 of the cap 310 can be mated with the coupler 220, as shown in FIG. 10C. In some examples, the cap 310 including the partial slit 360 (see FIG. 7C) can be similarly used.

In different examples, the cap 310 may include variously shaped inner lips 500 to engage rebar. The different shape of the lip, for example, may provide better sealing or easier adjustability for different sizes or different finishes of the rebar. Referring to FIGS. 11A-11C, for example, the cap 310 may include an inner skirt 510 that extends along the same direction of the side wall 370 from the cap surface 320. The cap 310 may also include an inlet 520 that extends from the inner skirt 510 in the opposite direction. The inlet 520 can thus define a tapered configuration for the central aperture 322, with further resiliency provided by the inner skirt 510.

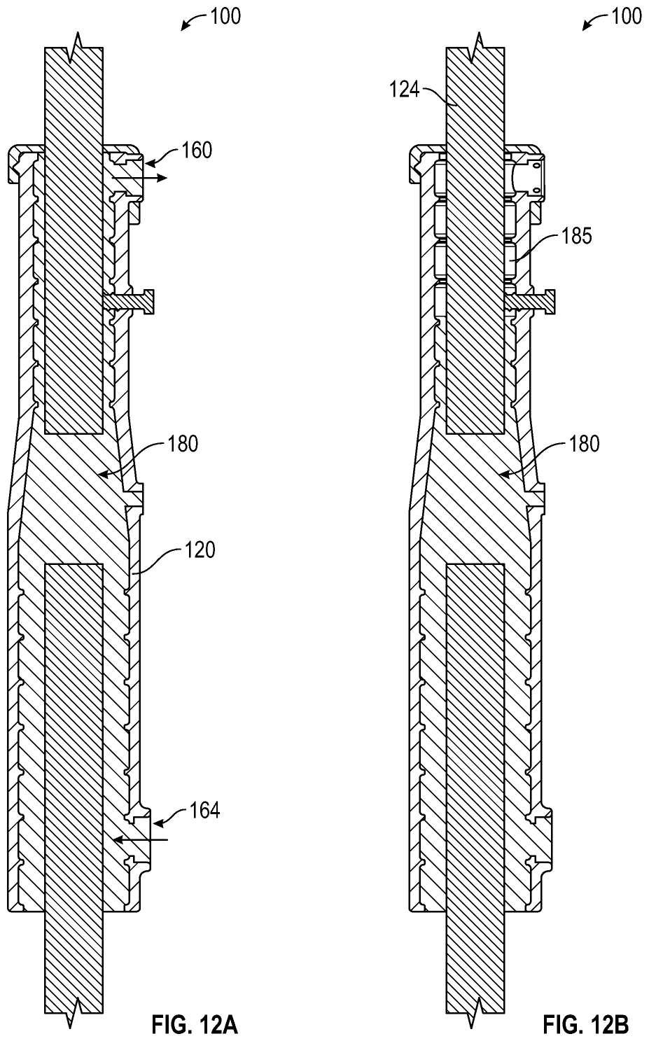

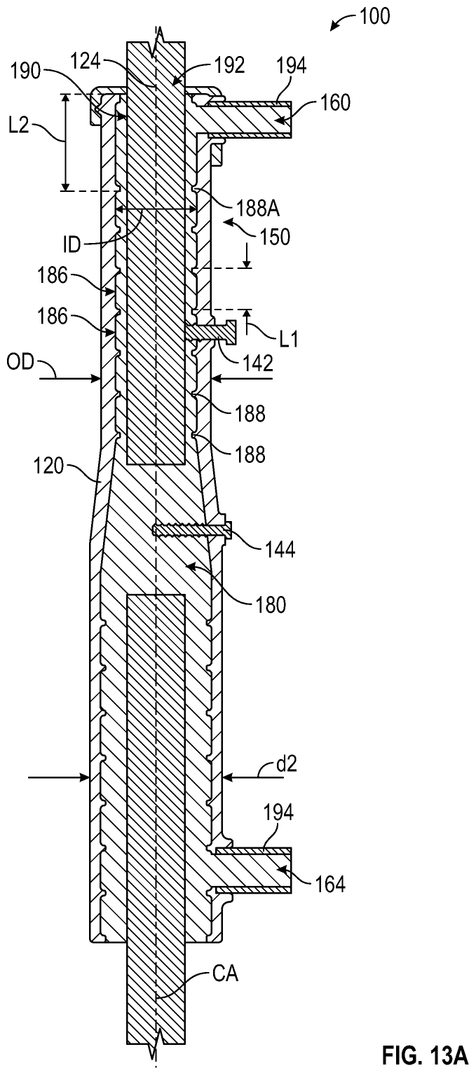

As described above, the first and second grout ports 160, 164 (e.g., the second grout port 164, as a fill port) can be used to pump in the grout into a coupler cavity within the coupler body 140 (see, e.g., FIG. 12A). In some examples, the grout-to-grout coupler can be used in a final vertical position (e.g., a “cups down” position), where the grout will be pumped from a bottom grout port (e.g., the port 164) until the coupler cavity is completely filled and the excess grout exits from a top grout port (e.g., the port 160).

Once the grout is pumped into the coupler cavity, entrapped air within the mixed grout slowly migrates upward and out of the grout. This is known as “off-gassing” and generally ceases when the grout is set. However, the off-gassing before the grout sets tends generally to reduce the fill height and volume of the grout fill within the coupler cavity.

FIGS. 12A and 12B illustrate a cross-sectional view of the rebar connector assembly 100 of FIG. 1 before and after, respectively, the off-gassing of the grout within a coupler cavity 180, with the coupler 120 in a final vertical position. Referring to FIG. 12A, for example, the grout can be pumped in from a bottom grout port 164 until the grout exits from a top grout port 160. The exiting from the top grout port 160 may provide an indication that the grout has filled the coupler cavity 180.

As the grout within the coupler cavity 180 then cures, off-gassing occurs. This can cause volumetric loss (or shrinkage) of the grout fill, as represented by the grout-less volume 185 in FIG. 12B. In particular, as shown in FIG. 12B, by the time the grout is set, the shrinkage that resulted from off-gassing can result in a notable reduction of a fill height of the grout. Indeed, in some cases, the rebar connector assembly 100 can experience a grout volume loss such that the embedment of the first rebar 124 into the grout is substantially reduced. For example, in the illustrated configuration, only about 30 percent of a length of the first rebar 124 within the coupler 120 may still be surrounded by the grout, which may not provide sufficient embedment. Or, from a different perspective, multiple cells between internal ribs of the coupler may no longer include grout to engage the rebar 124. This reduction in the effective embedment of the rebar in the grout may negatively impact the coupling strength between the first rebar 124 and the grout within the rebar coupler 120.

In some cases, additional volumetric loss of grout can occur when two precast elements are coupled via a rebar connector assembly 100 and grout is used to fill not only a coupler but also a joint between the concrete elements (e.g., as shown in FIG. 13B). The extra volume of the grout that fills the joint formed by the rebar connector assembly 100 will generate off-gassing in addition to the grout fill that is placed within the coupler cavity 180. Thus, filling in joints or gaps between the rebar connector assembly 100 may cause even greater volume loss and reduction in effective embedment depth of the rebar.

In order to mitigate the volumetric loss (demonstrated by grout-less volume 185) caused by off-gassing of the grout as illustrated in FIGS. 12A and 12B (or FIG. 13B, etc.), the body 140 of the rebar coupler 120 can include structural modifications as compared to conventional couplers. In particular, in some examples, the length or the diameter of the rebar coupler can be locally increased, relative to conventional designs, to compensate for the off-gassing process described above.

In this regard, for example, FIG. 13A illustrates a cross-section of rebar coupler 120 in a final vertical position. The rebar coupler 120 includes a plurality of cells 186 disposed along the first end 150 the coupler cavity 180, with each of the cells 186 defined between two adjacent ribs 188 that protrude inwardly toward a central axis CA from an inner diameter ID of the rebar coupler 120. Generally, the two adjacent ribs 188 are separated by a first length L1 along the longitudinal direction (e.g., parallel with the central axis), which defines the length of the corresponding cells 186.

Continuing, the body 140 of the rebar coupler 120 of the illustrated example includes an uppermost cell 190 that extends between an uppermost rib 188A and an upper aperture 192 that receives the rebar 124 adjacent to the top grout port 160. The upper aperture 192 and the uppermost rib 188A are separated by a second length L2, which defines the length of the uppermost cell 190.

To provide an improved engagement between grout and rebar even after off-gassing, the length L2 of the uppermost cell 190 can be greater than the length L1 of the remainder of the cells 186. Generally, the increased volume to be provided by the second length L2 can be determined by calculating an expected volume loss of the grout during off-gassing, and the length L2 can be selected to exceed the length L1 accordingly. In other words, by obtaining the expected volumetric loss of the grout from off-gassing, a useful length of the uppermost cell 190 can be calculated. For example, the volume loss of the grout during off-gassing may be between about 1.5% or about 15%, or between about 2% or about 10%, and the increase in the length L2 versus the length L1 can be determined accordingly, based on the inner diameter ID of the coupler 120 and the volumetric displacement of the inserted rebar 124.

In the illustrated example, the second length L2 of the uppermost cell 190 is twice the length L1 of the cells 186. More generally, the length L2 can be between 100% and 300% of the length L1 in some cases. Thus, the elongated length L2 of the uppermost cell 190 can serve as a sacrificial portion of the coupler cavity 180, such that sufficient engagement between the grout and the rebar 124 is maintained even after off-gassing.

As shown in FIG. 13B, for example, even in a case with a high degree of off-gassing (e.g., with grout in the rebar connector 120 or a rebar coupler and a joint, as shown), a sufficiently large engagement area between the grout and the rebar 124 can be maintained. As shown in FIG. 13B, the uppermost cell 190 may sometimes not include any grout after off-gassing. However, the shrunken grout may still surround the first rebar 124 with an embedment depth that provides sufficient holding strength within the coupler cavity 180.

While elongating the length of the uppermost cell 190 can mitigate the shrinkage caused by the off-gassing of the grout, it may be desirable in some cases to minimize the length of the rebar coupler 120. For example, shorter couplers may be easier to manipulate during prefabrication operations, or may be more easily cast in groups using standard casting procedures. Correspondingly, an uppermost cell 190 may sometimes include a wider cell width (e.g., an increased inner diameter of an end cell) to provide increased volume for the coupler cavity 180, with smaller (or no) increase in overall length of the coupler 120.

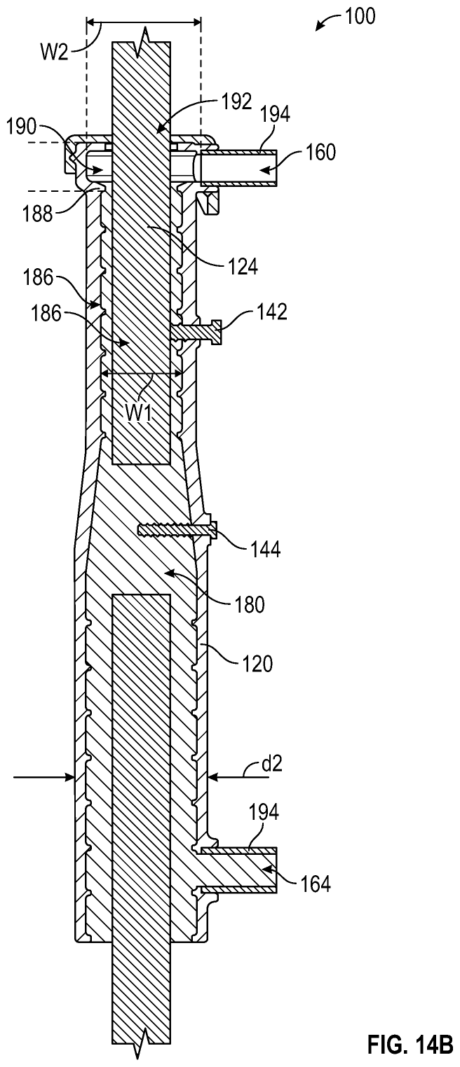

Referring now to FIG. 14A, for example, the rebar coupler 120 can include an uppermost cell 190 with a wider cell width than other cells of the coupler. The additional volume of the wider uppermost cell 190 may mitigate the volume loss caused by offgassing by providing additional overall volume of the coupler cavity 180, to enable sufficient embedment depth similar to the elongated cell length of the uppermost cell 190 of FIGS. 13A and 13B. For example, as shown in FIG. 14B, the grout in the coupler 120 after off-gassing may still engage all of the internal ribs 188, due to the larger width W2 of the uppermost cell 190. As generally discussed above, this can ensure sufficiently strong engagement with the rebar 124 despite the loss of grout volume.

In particular, in the illustrated example, the cells 186 include a first inner radius that defines a first width W1, and the uppermost cell 190 includes a second inner radius that defines a second width W2 that is greater than the first width W1. In some examples, the second width W2 of the uppermost cell 190 can result in an outer diameter of the rebar connector 120 (or a rebar coupler 120) that is equal to the second diameter d2 of the body 140 of the rebar coupler 120. In other words, the second width W2 of the uppermost cell 190 can be smaller than the second diameter d2 of the rebar coupler and greater than the first width W1 of the plurality of cells 186, with the overall outer diameter of the coupler 120 at the uppermost cell 190 being no larger than the diameter d2 of the wider end of the coupler 120. Generally, a sufficient volume for the upper cell 190 and a corresponding value for the width W2 can be determined as similarly discussed above relative to the increased length L2 of FIGS. 13A and 13B. In this regard, in some cases, an increased width W2 can be selected to provide an increase in volume of between 50% and 200% relative to other cells, inclusive.

In some cases, an uppermost cell can be configured with both increased length and increased width relative to other cells, with similar effect as discussed above relative to FIGS. 13A through 14B. In some cases, an increased width or length can be provided at another cell at an end of a coupler (e.g., an upper end for a vertical installation orientation), rather than or in addition to an increased width or length at an uppermost cell.

In some examples, insufficient final volume of grout can also (or alternatively) be caused by incomplete initial fill. For example, an installer may stop pumping grout into a coupler at first sign of grout in an outlet tube, when the pumping should not stop until the inner diameter of the exit (e.g., top) grout port 160 is fully filled of exiting grout. Further, in some examples, the top grout port 160 may be disposed below a maximum height of the internal coupler cavity 180, which may also contribute to the coupler cavity 180 not being filled in full—e.g., particularly in combination with premature stoppage of pumping, as discussed immediately above.

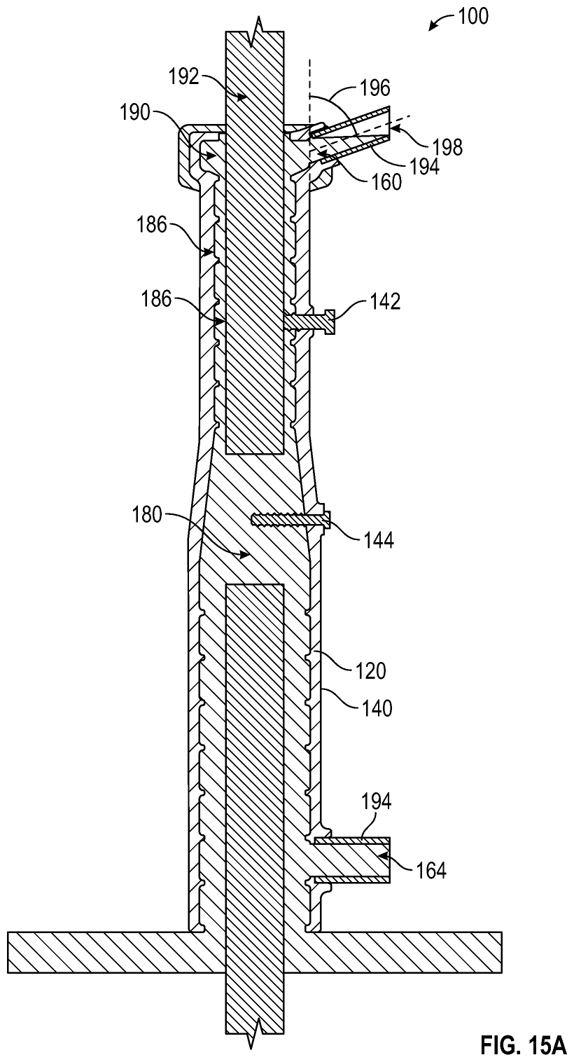

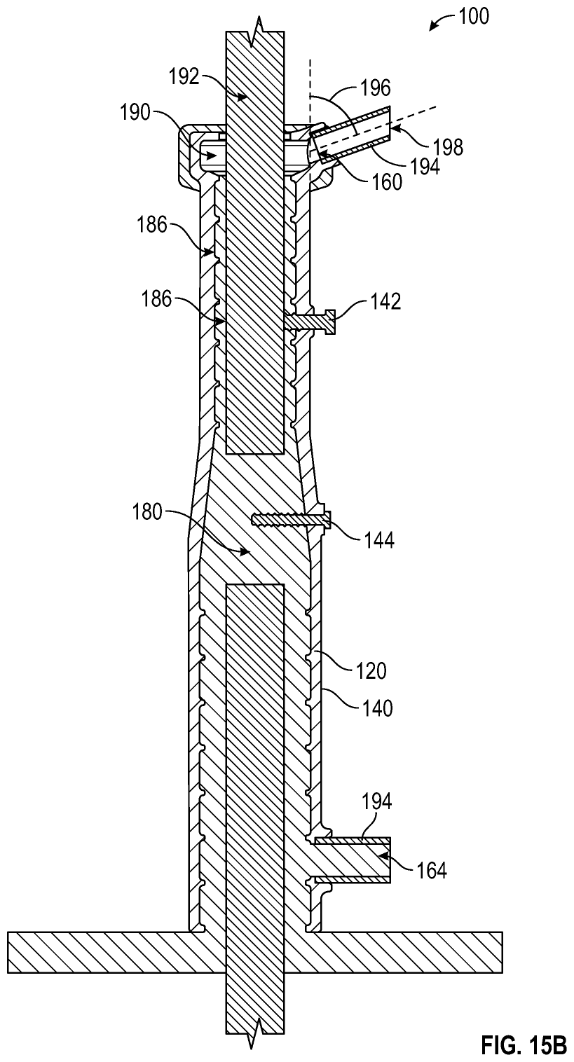

To address this issue, in some examples, a grout port may be angled or may include an angled piping arrangement so that an operator will not detect exiting grout until a sufficient amount of grout has been pumped into the coupler. For example, as shown in FIG. 15A, in order to mitigate incomplete fill of the coupler 120, the top grout port 160 can be angled upward toward (e.g., and also past) the upper aperture 192 of the rebar coupler 120. In particular, as shown in FIG. 15A, the top grout port 160 can be upwardly tilted at an angle 196. Thus, when the top grout port 160 is coupled to a PVC pipe 194 (or other outlet passage), an outlet 198 of the PVC pipe 194 can extend above the top of the rebar coupler 120. Accordingly, the grout may fully fill the cavity 180 before grout first begins to flow out of the PVC pipe 194, as shown in FIG. 15A. As a result, as shown in FIG. 15B, a sufficient amount of grout may still remain in the cavity 180 even after off-gassing.

In this regard, as similarly discussed above, the tilted angle 196 can in some cases be selected based on the amount of volumetric loss expected to be caused by the off-gassing, or based on a total length of the coupler 120 and an expected length of the PVC pipe 194. In some examples, the tilted angle 196 can be between about 85 degrees and about 45 degrees.

Although the port 160 is shown as an integrally formed angled structure in the illustrated example, other configurations are possible. For example, the port 160 can be formed as a radial port rather than an angled port, and an angled outlet pipe can be attached thereto. In some examples, a perpendicular (or other) grout port can support a bent outlet pipe (e.g., a bent PVC pipe or a street elbow), which can provide similar benefits as a tilted grout port.

As illustrated in FIGS. 13A through 15B, the aperture 166 can receive the stop 144 (e.g., a set screw, as shown) and the hole 162 can receive a set screw 142. The stop 144 allows a rebar to be stopped within the coupler cavity 180 and the set screw 142 can help to hold the rebar in place until the grout is set. However, both the aperture 166 and the hole 162 can create high stress areas within the body 140 of the rebar coupler 120.

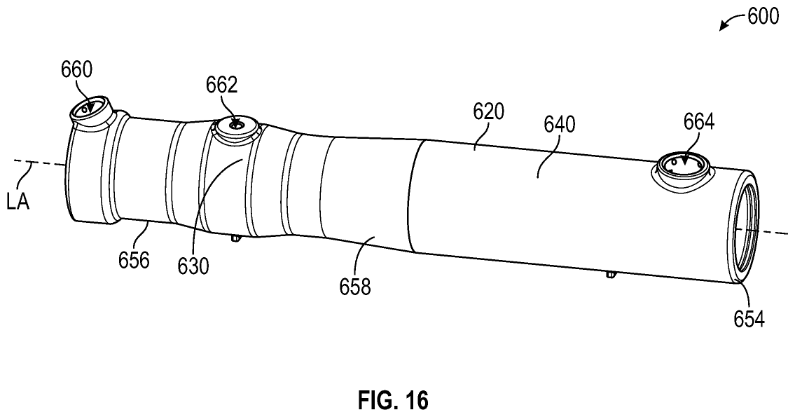

To mitigate these stress concentrations, some examples (e.g., other configurations of the coupler 120) can include increased wall thicknesses, or can include fewer openings. For example, FIG. 16 illustrates a rebar connector assembly 600 including a rebar coupler 620. The rebar coupler 620 includes a body 640, and a threaded hole 662 that is disposed about a thickened region 630 along a first end 650 of the body 640. Further, the aperture 166 of FIG. 1 has been removed.

The body 640 of the rebar coupler 620 may be a hollow tube shape, including with a generally circular cross-sectional profile similar to the rebar connector assembly 100 of FIG. 1. In particular, the body 640 includes a first end 650, a second end 654 opposite of the first end 650. The body 640 includes a first transitional region 656 and a second transitional region 658. The first transitional region 656 is disposed between a first grout port 660 and the thickened region 630 and the second transitional region 658 is disposed between the second grout port 664 and the thickened region 630.

More specifically, the hole 662 is disposed between the first and second transitional region 656, 658 and is surrounded by the thickened region 630 that extends circumferentially around the rebar coupler 620 between the transitional regions 656, 658. The thickened region 630 can help to mitigate the stress concentration within the body 640 of the rebar coupler 620 caused by the hole 662. In some examples, the body 640 may include a plurality of holes and a plurality of thickened regions disposed correspondingly about the plurality of holes between the first grout port 660 and a second grout port 664 along the longitudinal axis LA (or one or more extended thickened regions having multiple holes).

As similarly discussed above, the first and second grout port 660, 664 can be selectively used to pump in the grout at either end of the body 140. In the illustrated example, the first grout port 660 (e.g., as a smaller exit port) is tilted at a non-perpendicular angle relative to the longitudinal axis LA and the second grout port 664 (e.g., as a larger inlet port) is disposed perpendicular to the longitudinal axis LA adjacent to a free end of the rebar coupler 620. As also discussed above, this can help to ensure sufficient grout is filled into the rebar coupler 620 during installation. In other examples, however, other configurations are possible.

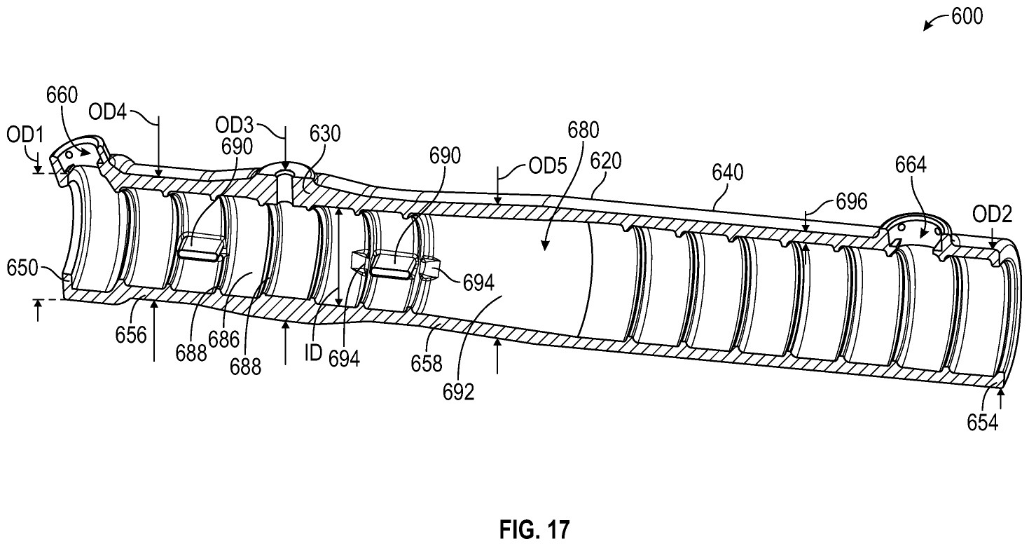

Referring to FIG. 17, the first end 650 of the body 640 defines a first outer diameter OD1, the second end 654 of the body 640 defines a second outer diameter OD2, and the thickened region defines a third outer diameter OD3. The first transitional region 656 defines a fourth outer diameter OD4 and the second transitional region 658 defines a fifth outer diameter OD5. In some examples, the transitional regions 656, 658 may be tapered to provide a gradual transition between the adjacent diameters. In the illustrated example, the second translational region 658 of the body 640 includes a constant-slope linear taper that is adjacent to the thickened region 630 and the first transitional region 656 includes a constant outer diameter. Further, the first outer diameter OD1 corresponds to a widened end cell as similarly discussed above relative to FIGS. 14A and 14B.

Continuing, a coupler cavity 680 within the rebar coupler 620 includes a plurality of cells 686 disposed between sets of adjacent ribs 688. Further, some of the cells 686 include pads 690 extending outwardly from an inner surface 692 of the coupler cavity 680. In the illustrated example, the pads 690 extend longitudinally between the ribs 688, although other configurations are possible. Further the plurality of pads 690 may include side reinforcement pads 694 that taper from the ribs 688 toward the inner surface 692 of the coupler cavity. The tapered side reinforcement pads 694 can help to reduce (e.g., eliminate) a stress concentration that might occur near the root of the pads 690. The plurality of cells 686 define an inner diameter ID of the rebar coupler 620 and the inner diameter ID may vary between the first and second grout port 660, 664.

The rebar coupler 620 includes a coupler thickness 696 that can be measured by obtaining the difference between the outer diameters (e.g., first, second, third, fourth or fifth outer diameters OD1 through OD5) and the inner diameter ID. In some examples, the coupler thickness 696 can be constant throughout the rebar coupler 620. In the illustrated example, the coupler thickness 696 is different throughout different regions of the rebar coupler 620. For example, the thickened region 630 of the illustrated example includes increased coupler thickness 696 in order to mitigate the high stress concentration about the hole 662. In other words, the third outer diameter OD3 provides an increased thickness relative to other regions of the rebar coupler 620, while the inner diameter ID at the first end 650 may remain smaller than an inner diameter at the second end 654.

As described above, the aperture 166 for the radially inserted rebar stop, as shown in FIG. 1, is not included in the rebar coupler 620 of FIG. 16. The exclusion of the aperture 166 eliminates high stress concentrations which allows the rebar coupler 620 to withstand large loads placed upon the rebar coupler 620. However, for prefabrication operations, a rebar stop is a desirable feature to help ensure insertion of a first rebar to a proper depth for pouring and curing of prefabricated concrete sections.

As described above, various caps (see FIGS. 7A-7C and 11A-11C) can be secured about the first end 650, including for modified and unmodified rebar coupler. In this regard, although a particular is discussed relative to the particular examples above, it should be understood that other arrangements are possible. For example, the caps discussed relative to particular rebar coupler above can be substituted into or otherwise added onto various other rebar couplers.

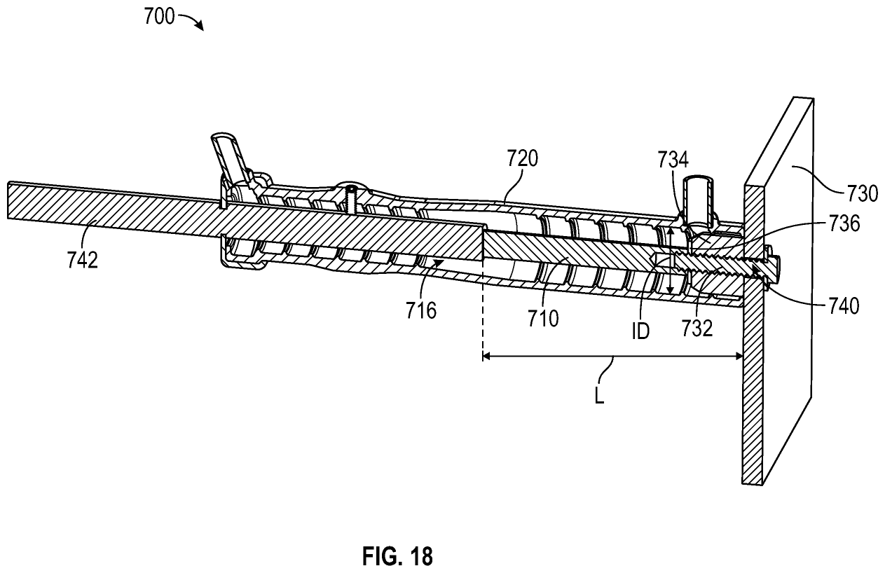

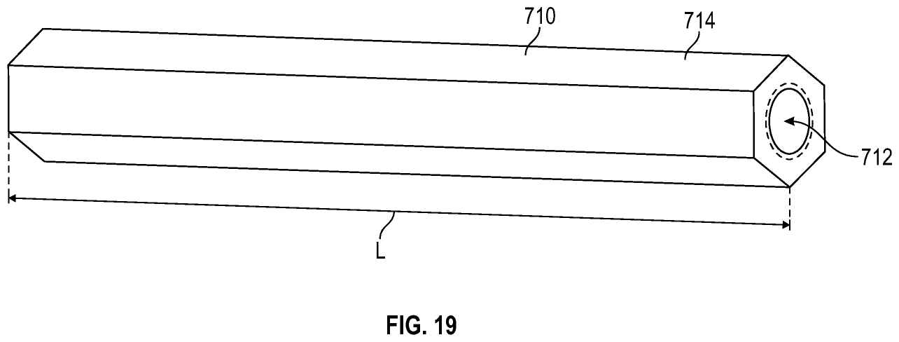

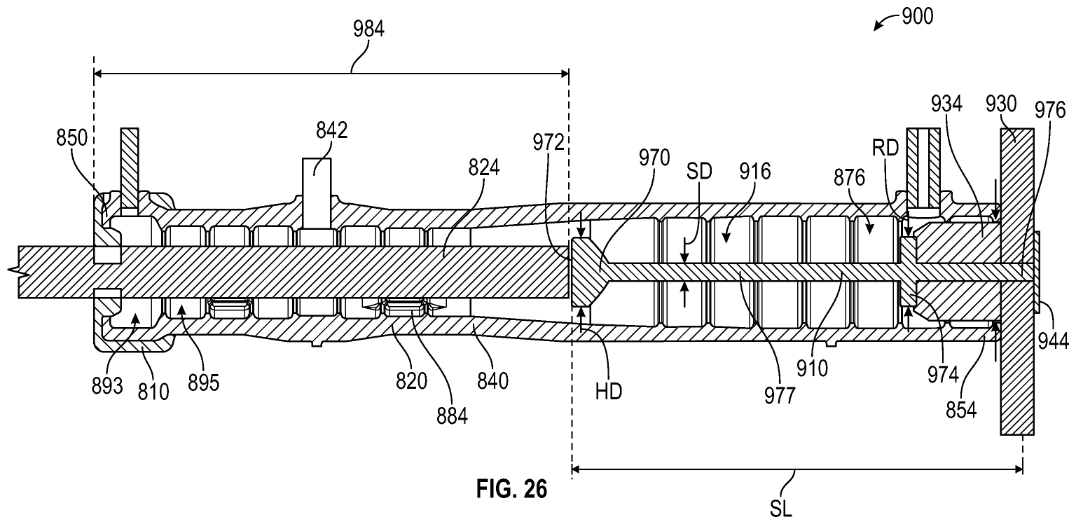

In this regard, some examples can include a reusable (or other) stop assembly that can be inserted from an axial end of a coupler during prefabrication to provide a stop for a first length of rebar, then removed for installation of the prefabricated section at a job site. For example, FIG. 18 illustrates a reusable stop assembly 700 that is configured to support an elongated stop 710 within an interior volume 716 of a rebar coupler 720 (e.g., configured similarly to the rebar coupler 620). Referring to FIG. 19, in particular, the elongated stop 710 is formed as a body of material with a predefined length and a tapped hole 712 at a first end 714. In the current example, the elongated stop 710 is a hexagonal bar, although other geometries are possible (e.g., as discussed relative to FIG. 26). Further, although a tapped configuration may allow for easy assembly and adjustment of the stop assembly 700, other configurations are also possible in this regard.

Referring back to FIG. 18, the reusable stop assembly 700 can be coupled to a concrete form 730 so as to support the coupler 720 and align the elongated stop 710 within the coupler 720. In the illustrated example, in particular, the reusable stop assembly 700 includes a bolt 732, a grommet 734 (e.g., of elastomeric material), and a washer 736. The concrete form 730 includes an outer hole 740 that receives the bolt 732. As the bolt 732 is tightened, the grommet 734 is compressed axially by the washer 736, and thus correspondingly expands radially to be urged against an inner diameter ID of the rebar coupler 720. Thus, the compressible grommet 734 can secure the coupler 720 to the concrete form 730, while supporting the elongated stop 710 to extend within the rebar coupler 720.

When thus installed, the elongated stop 710 provides a rigid stop for a length of rebar 742 that is inserted into the coupler 720 opposite the concrete form 730. Accordingly, a length L of the elongated stop 710 can define a stop location that can be selected based on the size of the rebar coupler 720 and the desired insertion depth of the rebar 742. Once the elongated stop 710 and the rebar 742 is in place, concrete (not shown) can be poured and cured around the rebar 742 and the coupler 720, thus securing the rebar 742 at the appropriate insertion depth relative to the coupler 720. The bolt 732 can then be loosened to release the coupler 720 from the grommet 734 and correspondingly also release the concrete form 730 from the cured concrete.

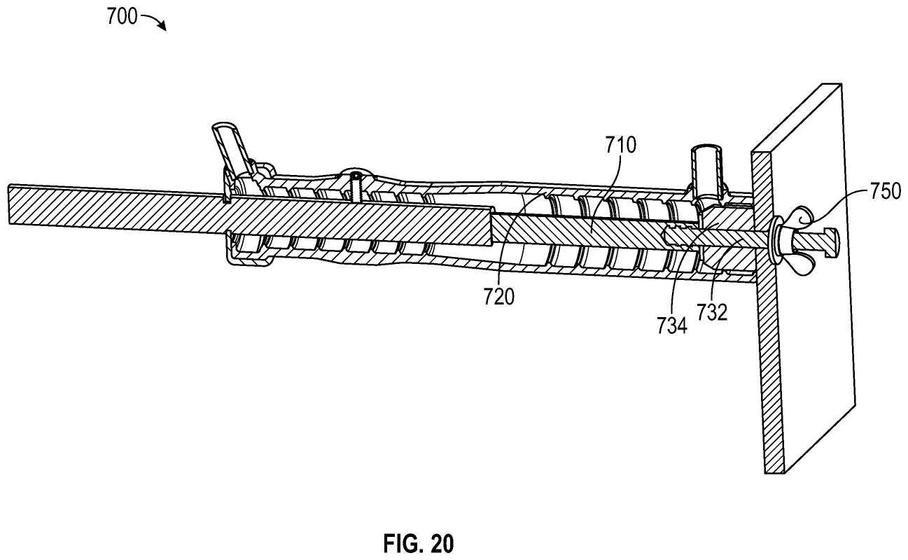

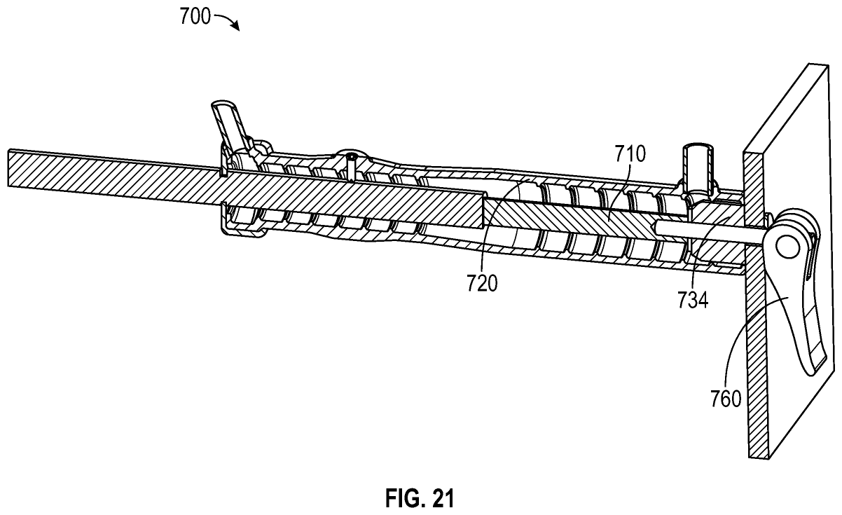

In different examples, the reusable stop assembly 700 can be implemented with different types of fastening mechanisms. Referring to FIG. 20, for example, a wing nut 750 can be used to provide easier adjustment of the bolt 732 to secure the coupler 720 to the grommet 734. Referring to FIG. 21, in another example, a cam lever 760 can be similarly used.

In some examples, different devices can be used to secure a stop assembly to a coupler. For example, rather than an internal grommet, a stop assembly can include a sleeve or other structure configured to engage an exterior of a coupler, and thus support a rigid stop within the coupler similarly to the examples discussed above. As another example, an expandable (or other) anchor other than a grommet can be used internally to a rebar connector. For example, some anchors can include expandable fingers or other gripping mechanisms (e.g., snap-engagement features) to engage an interior (or other surface) of a rebar coupler.

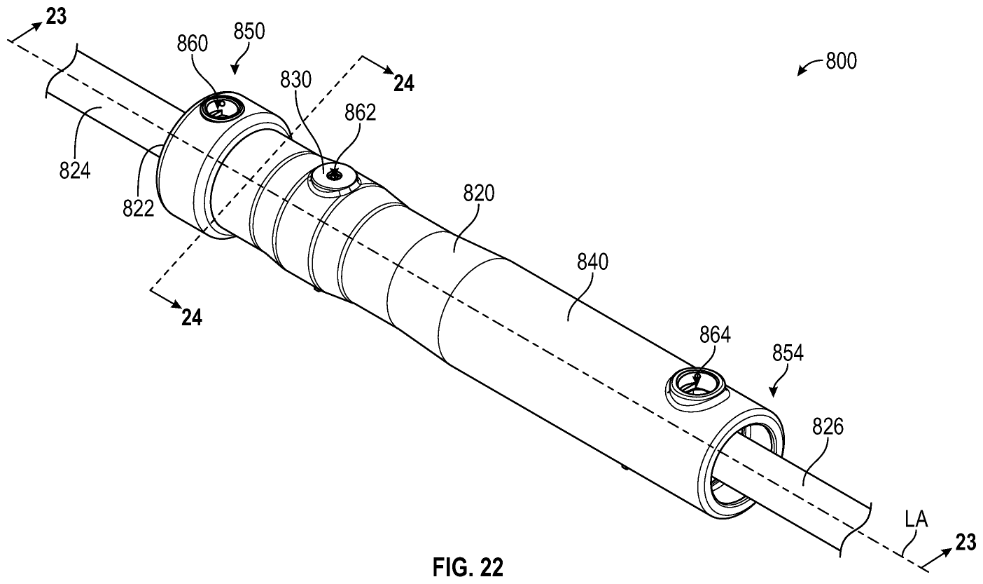

Referring now to FIG. 22, a rebar connector assembly 800 is shown. Generally, the rebar connector assembly 800 is an alternative configuration of the rebar connector assembly 600 of FIG. 16. To that end, a connector of the assembly 800, configured as a rebar coupler 820, includes reference numbers that are generally similar to those used in FIG. 16 relative to the rebar coupler 620, and discussion of similarly numbered components above similarly applies below. For example, the rebar coupler 820 includes a coupler body 840 that may be a hollow tube shape with a generally circular cross-sectional profile between a first end 850, and a second end 854 opposite of the first end 850, and an internal volume 876 (see FIG. 24) that extends along a longitudinal axis LA.

In some regards, the configuration of the coupler 820 differs from that of the rebar coupler 620 of FIG. 16. For example, a first grout port 860, opposite of a second grout port 864, of the rebar coupler 820 extend substantially perpendicular to the longitudinal axis LA (although attached piping can provide differently oriented grout passages, as also discussed above). In some examples, the hole 862 can be threaded similarly to the hole 662, although other configurations are possible, including various smooth sided or other bores configured to receive a locking member (e.g., a set screw 842 (see FIG. 24), a pin, another threaded or other fastener, etc.).

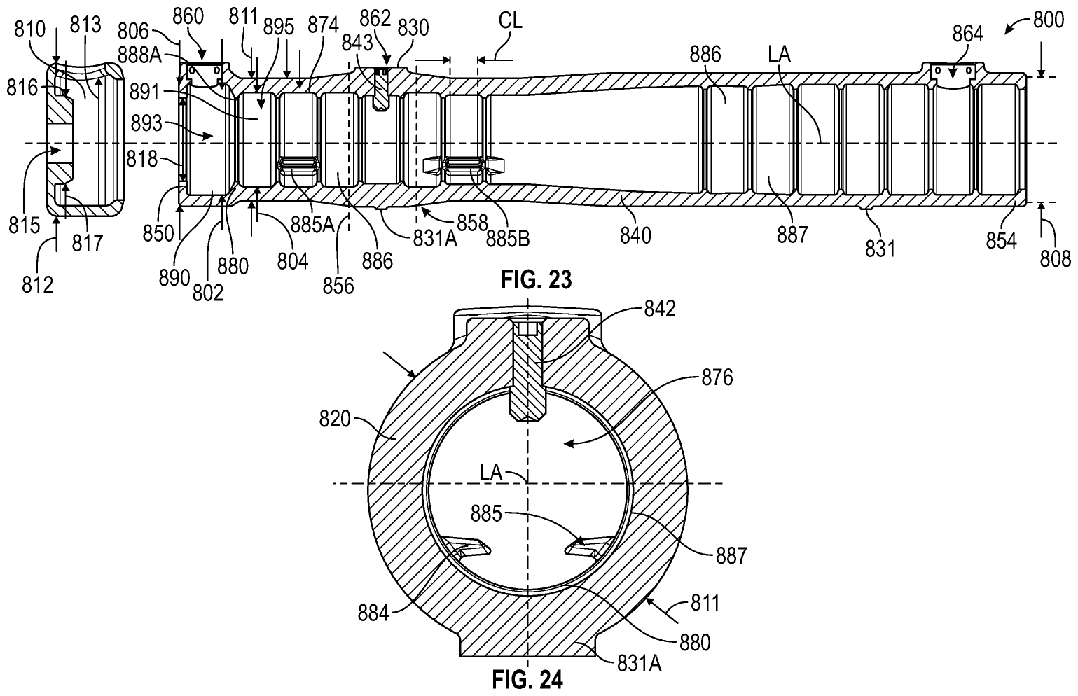

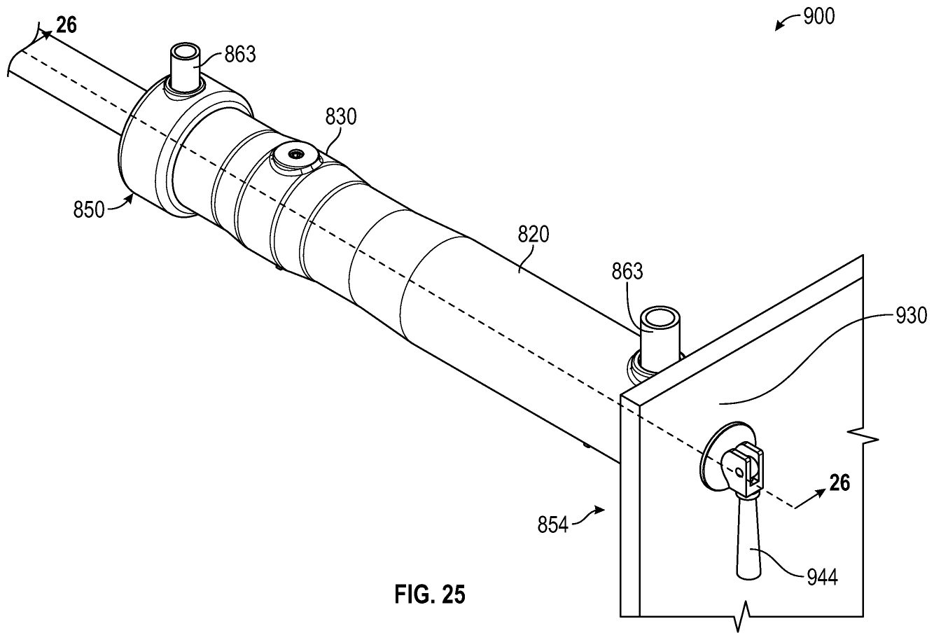

As illustrated in FIG. 23, the coupler body 840 includes one or more grout ports that open into the hollow interior. In the illustrated example, the coupler body 840 includes the first grout port 860 on the first end 850 of the coupler body 840 and the second grout port 864 on the second end 854 of the coupler body 840. In some installations (e.g., for prefabrication operations), the first grout port 860 and the second grout port 864 can support a respective tube 863 (see FIG. 25) that extends beyond the coupler body 840 to receive or vent grout (e.g., into the port 864, and out of the port 860). In some examples, the outlet tube 863 extends perpendicular to the longitudinal axis LA.

As similarly described above, the hollow interior includes plurality of ribs (or internal ribs) 880 that defines cells 886 to engage grout that is received within the coupler body 840. The cells 886 include a cell 890 (e.g., an end cell, as shown) and a cell 891 that is adjacent to the cell 890. In particular, the cells 890, 891 are separated by a rib 888A (e.g., an end rib, as shown). Further, the first rib separates the first cell 890 from the second cell 891 such that the first grout port 860 is disposed on an opposite side of the first rib 888A from the second cell 891. Correspondingly, as grout fills the coupler body 840 from the right relative to FIG. 23, grout may substantially fill the cell 891 before entering the cell 890 and venting (e.g., visibly) out of the port 860.

To provide improved performance relative to grouted connections, the cell 890 defines a volume 893 to receive grout that is larger than a volume 895 defined by the second cell 891. In the illustrated example, the cells 890, 891 are cylindrical in shape about the longitudinal axis LA, although other shapes are possible. Correspondingly, the volume 893 is defined by a diameter 802 of the cell 890 and the volume 895 is defined by a diameter 804 of the cell 891. In this regard, larger volume 893 can help to compensate for the shrinking of the grout within the coupler body 840 or underfilling by installers. In particular, the volume 893 may beneficially be between about 50% and about 200% larger than the volume 895, inclusive, to optimally balance performance during grouting operations with overall coupler size.

As described above, various coupler bodies according to the disclosed technology can include cells (e.g., divided by ribs), including with variations between shape or sizes of adjacent (or other) cells. In this regard, although a particular design is discussed relative to a coupler that includes the differing volumes 893, 895, it should be understood that other arrangements are possible. For example, an arrangement of cells as presented within the coupler body 840 can be substituted into coupler bodies otherwise similar to various others disclosed herein (e.g., in any of the configurations illustrated in the various FIGS. Similarly, increased volumes via extended cell length (e.g., as shown in FIGS.). can be used with other coupler bodies disclosed herein. For instance, to provide a larger volume in some configurations, a length of the cell 890 along the longitudinal direction parallel to the longitudinal axis LA can be greater than a length of the cell 891 along the longitudinal direction. In some cases, however, a radially enlarged cell may provide a more efficient design, because a relatively greater increase in cell volume can be achieved with a relatively small increase in total coupler size.

As shown in FIG. 23, the first end 850 of the coupler body 840 includes a first outer diameter 806 and the second end 854 of the coupler body 840 includes a second outer diameter 808. In the illustrated example, the first outer diameter 806 of the coupler body 840 about the first end (or the first cell) is substantially equal to the second outer diameter 808 of the coupler body 840 about the second end 854. Furthermore, a third outer diameter 811 of the coupler body 840 measured along the second cell 891 is smaller than the second outer diameter 808 about the second end 854. In other words, the first outer diameter 806 of the coupler body 840 along the first cell 890 is not wider than the second outer diameter 808 along the second end 854 of the coupler body 840, and a consistent maximum radial envelope for the coupler body 840 can be maintained at both ends 850, 854.

Still referring to FIG. 23, a cap 810 can be secured about a first end 850 of the rebar coupler 820. For instance, the cap 810 can be secured onto the coupler body 840 by receiving of the first end 850 of the rebar coupler 820. The cap 810 includes a cap outer diameter 812 that is greater than a cap inner diameter 813. The cap 810 also includes an inlet 815 that is configured to receive a portion of a first rebar 824 into the hollow interior of the coupler body 840. The inlet 815 of the cap 810 includes an inlet wall 816 with an inlet wall diameter 817 that is greater than a first opening diameter 818 about the first end 850.

As described above, various caps can be secured about the first end 850, including for modified and unmodified rebar coupler 120, 220, 620, 820. In this regard, although a particular is discussed relative to the particular example above, it should be understood that other arrangements are possible. For example, the caps discussed relative to particular rebar coupler above can be substituted into or otherwise added onto various other rebar couplers 120, 220, 620, 820.

The coupler body 840 includes a first transitional regions 856 and a second transitional region 858. The first transitional region 856 is disposed between the first grout port 860 and a thickened region 830 and the second transitional region 858 is disposed between the second grout port 864 and the thickened region 830. More specifically, a hole 862 is disposed between the first and second transitional regions 856, 858 and is surrounded by the thickened region 830 that extends radially around the hole 862. As mentioned above, the thickened region 830 can help to mitigate the stress concentration about the hole 862 of the coupler body 840. The hole 862 is configured to receive a locking member (e.g., the set screw 842, a pin, etc.). The set screw 842 received by the hole 862 is configured to secure a first length or a portion of the first rebar 824 to provide alignments with the pads 884 which will be discussed below.

In some examples, flanges 831 may protrude on the opposite side of the thickened region 830 to allow the coupler to be more stably balanced on a work surface. In some examples, at least one flange 831A of the flanges 831 can be disposed directly opposite of the set screw 842.

Referring now to FIG. 24, pads 884 can extend within the rebar coupler 820, to orient and help secure a portion of the first rebar 824 within the internal volume 876 (e.g., when the set screw 842 is tightened or other locking member is engaged). In the illustrated example, the pads 884 extend between adjacent sets of the ribs 880, as may provide improved overall strength, although other configurations are possible. Further, the pads are arranged on opposing sides of the set screw 842, relative to the longitudinal axis LA. Thus, the pads 884 can provide particularly stable support for rebar in opposition to the axially offset holding force of the set screw 842. In particular, referring back to FIG. 23, the pads 884 may be arranged as two axially aligned sets of pads: a first set of pads 885A spaced longitudinally apart from the hole 862 toward the first end 850 of the coupler body 840 (e.g., within the first transitional region 856), and a second set of pads 885B spaced longitudinally apart from the hole 862 toward the second end 854 of the coupler body 840 (e.g., within the second transitional region 858).

In some examples, the first and second set of pads 885A, 885B can be formed as protruding ribs. In particular, the protruding ribs of the illustrated example are elongated along a longitudinal direction parallel with the longitudinal axis LA. Further, some pads can extend non radially from an inner surface 874 of the coupler body 840. For example, each of the pads 884 as shown forms a shelf, which extends substantially horizontally but offset from a vertical center of the coupler (e.g., extending as a non-diametric secant segment. In other example, however, other geometries are also possible.

Accordingly, the relative location of the sets of pads 885A, 885B and the set screw 842 can ensure that the first rebar 824 (see FIG. 22) is appropriately constrained relative to six degrees of freedom (e.g., as the set screw 842 engages a first section 822 of the first rebar 824 (see FIG. 22)). In this regard, for example, the set of pads 885A, 885B and the set screw 842 can constrain rotational movement as well as axial movement between the coupler body 840 and the first rebar 824.

Referring now to FIG. 25, a coupler system including a reusable stop assembly 900 for rebar is shown. Generally, the reusable stop assembly 900 is an alternative configuration of the reusable stop assembly 700 of FIG. 18. To that end, the features of the reusable stop assembly 900 include reference numbers that are generally similar to those used in FIG. 18, and discussion of similarly numbered components above similarly applies below. Further, the assembly 900 includes in particular the rebar coupler 820, although other couplers can be used in other configurations. Accordingly, as shown in FIG. 25, the reusable stop assembly 900 includes the rebar coupler 820 that receives an elongated stop body 910 and an anchor (e.g., a grommet 934, as shown), and a fastening mechanism 944 to secure the stop body 910 to a concrete form 930. In particular, referring to FIG. 26, the grommet 934 can be received within the internal volume 876 of the coupler 820, to secure the coupler 820 to the concrete form 930 (e.g., as similarly described relative to the grommet 734, discussed above).

As described above, various couplers described above can be used for the reusable stop assembly 900, including modified and unmodified rebar couplers. In this regard, although a particular is discussed relative to the particular example above, it should be understood that other rebar couplers are possible. For example, the rebar coupler 120, 220, 620, 1020 described herein can be used instead of the coupler 820. As also noted relative FIG. 21, the fastening mechanism 944 can be otherwise configured in other examples (e.g., to include a nut rotatable to compress the grommet 934, other known threaded fastener arrangements, or other levers or cam devices).

As also shown in FIG. 26, the shape of the stop body 910 of the reusable stop assembly 900 can be different from the shape of the stop 710. In this regard, for example, an enlarged end profile may provide various benefits, as further discussed below. More specifically, the stop body 910 includes a head portion 970 that is disposed at a first end 972 of the stop body 910 and a medial ring 974 that is disposed between the first end 972 and a second end 976 of the stop body 910. The head portion includes a head diameter HD and the medial ring includes a ring diameter RD. The head diameter HD and the ring diameter RD are both greater than a shaft diameter SD of a shaft 977 of the stop body 910. The ring diameter RD and the head diameter HD can be substantially identical or can be different. In some examples, the head portion 970 tapers toward the medial ring 974. The medial ring 974 can provide an enlarged area to engage and compress the grommet 934 to temporarily secure the coupler 820 to the concrete form 930.

Similar to the reusable stop assembly 700 of FIG. 18 discussed above, the reusable stop assembly 900 can be used to create a concrete structure. During a first operation, the coupler 820 can be secured to a concrete form with the stop assembly 900. More specifically, the coupler body 840 is secured so that first end 850 extends away from the concrete and the second end 854 receives the grommet 934 to be secured to the concrete form 930. The stop body 910 correspondingly extends within the internal volume 876 of the coupler body 840 to provide a stop for a first length 984 of the first rebar 824 within the internal volume 876.

During a second operation, the first rebar 824 can be inserted into the hollow interior via the first end 850 of the rebar coupler 820, until the first rebar 824 contacts the stop body 910 at the first length 984. The cap 810 can be connected to the coupler 820, as needed (e.g., being connected to the first rebar 824 before the second operation noted above). During a third operation concrete can be poured around the first length 984 of rebar and the rebar coupler 820 (e.g., while being excluded from the internal volume 876 by the cap 810). A fourth operation can include, after the poured concrete sets, removing the stop assembly 900 and the concrete form 930 from the coupler 820 and the concrete, with the first rebar 824 and the coupler 820 remaining embedded in the concrete and the second end 854 of the coupler 820 open to receive a second rebar (as further discussed below).

In some examples, after inserting the first length 984 of the first rebar 824 into the internal volume 876 and before pouring and curing the concrete, the set screw 842 (or another locking member) can be advanced to secure the first length 984 of the first rebar 824 within the internal volume 876 against the pads 884.

Continuing, after the stop assembly 900 and the concrete form 930 are removed, a second length of second rebar 826 (see FIG. 22) via the end 854. Grout can then be introduced into the interior volume 876 to surround and secure the first and second rebar 824, 826 therein. In this regard, the enlarged volume 893 (relative to the volume 895) can function similarly and provide similar benefits as are discussed relative to the use of grout in FIGS. 14A and 14B.

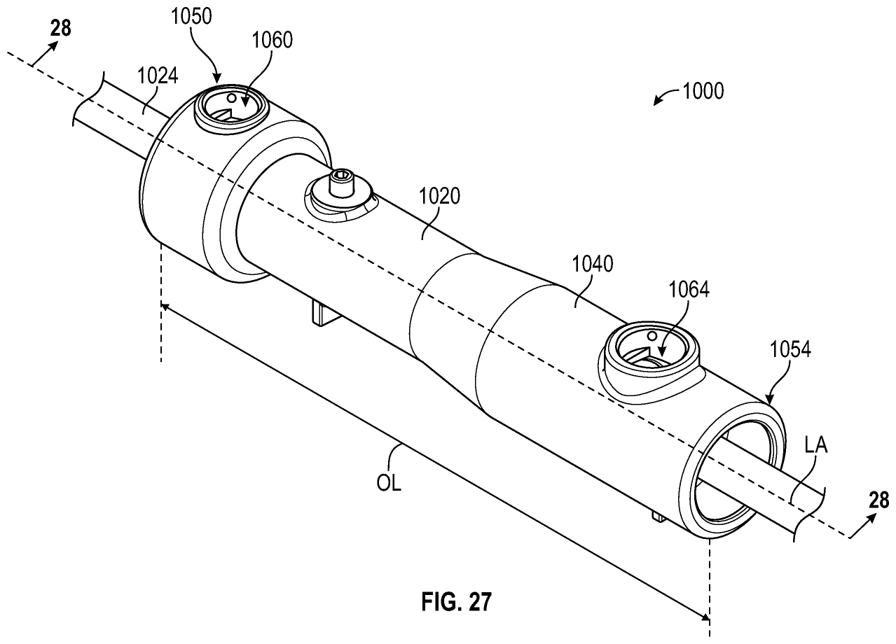

Referring now to FIG. 27, a rebar connector assembly 1000 is shown. Generally, the rebar connector assembly 1000 is an alternative configuration of the rebar connector assembly 800 of FIG. 22. To that end, the features of the rebar coupler 1020 include reference numbers that are generally similar to those used in FIG. 22, and discussion above applies similarly below. For example, the rebar coupler 1020 includes a coupler body 1040 that may be a hollow tube shape with a first grout port 1060, a second grout port 1064, and a generally circular cross-sectional profile between a first end 1050 and a second end 1054 along a longitudinal axis LA. However, an overall length OL of the rebar coupler 1020 is truncated as compared to the coupler 820.

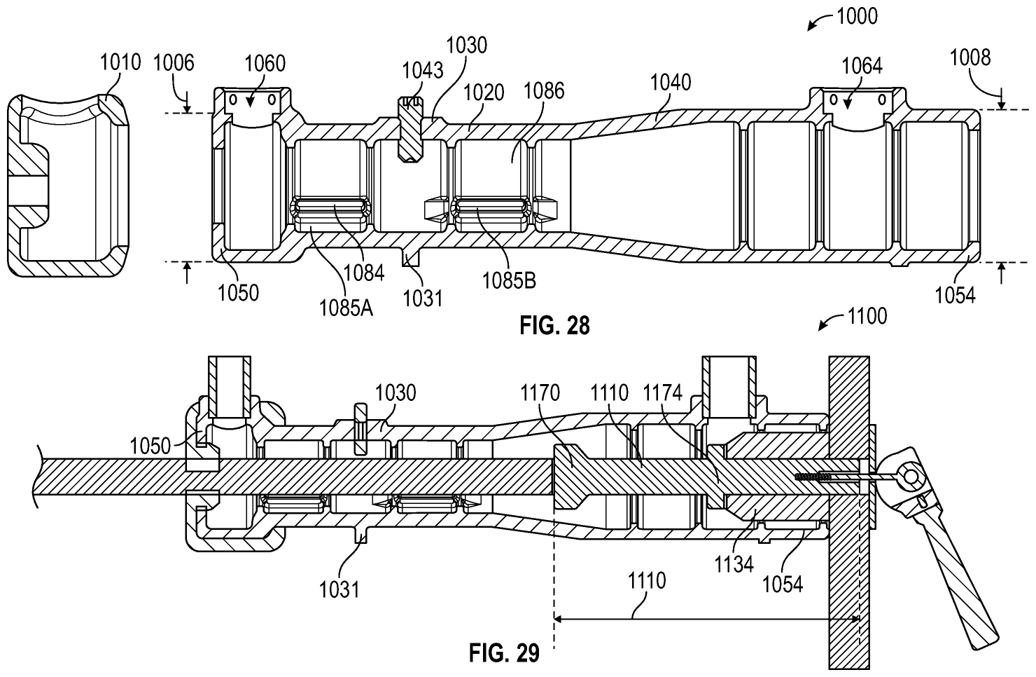

Referring now to FIG. 28, corresponding to the truncated length of the rebar coupler 1020, the number of cells between the first end 1050 and the second end 1054 can be different than shown for the coupler 820. Further, in some examples, a truncated length may also correspond to a smaller diameter, to receive smaller rebar 1024, 1026 (see FIG. 27). For example, a first outer diameter 1006 of the coupler body 1040 can be smaller than the first outer diameter 806 of the coupler body 840 of FIG. 23. Similarly, a second outer diameter 1008 of the coupler body 1040 about the second end 1054 can be smaller than the second outer diameter 808 along the second end 854 of the coupler body 840.

Referring to FIG. 29, the coupler 1020 can be used in operations similar to those described for the coupler 820 relative to FIG. 26. For example, to secure the first rebar 1024 within the hollow interior of the coupler body 1040, a locking member 1043 can inserted through a thickened region 1030 such that the locking member 1043 engages a surface of the first rebar 1024. In particular, the locking member 1043 engages the first rebar 1024 above pads 1084 such that the first rebar 1024 is secured between the locking member 1043 and the pads 1084 substantially coaxial with the longitudinal axis LA of the coupler body 1040. In some examples, a flange 1031 extending opposite of the locking member 1043 may protrude to be flush with the first outer diameter 1006 of the coupler body 1040. In some examples, a cap 1010 can be secured about the first end of the rebar coupler 1020.

Furthermore, referring to FIG. 29, corresponding to the shorter length of the rebar coupler 1020, a reusable stop assembly 1100 can also be generally shorter than the configuration shown in FIG. 26. Generally, however, the stop assembly 1100 is an alternative configuration (e.g., shortened) of the stop assembly 900 of FIG. 25. To that end, the features of the stop assembly 1100 include reference numbers that are generally similar to those used in FIG. 25, and discussion above similarly applies below. In this regard, for example, although an elongate length EL of a stop body 1110 is shorter than the elongated stop body 910 shown in FIG. 26, the stop body 1110 similarly includes a head portion 1170, a medial ring 1174, and an anchor or a grommet 1134.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

Thus, for example, some examples of the disclosed technology can include improved couplers for grout-to-grout connections and corresponding improved methods for forming concrete or securing concrete structures together using the couplers disclosed herein. Similarly, some examples can include manufacturing or using sets of substantially identical couplers (of one or more sizes) for prefabrication or for on-site operations.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or defined, “integral” and derivatives thereof (e.g., “integrally”) describe elements that are manufactured as a single piece without fasteners, adhesive, or the like to secure separate components together. For example, an element stamped or cast as a single-piece component from a single piece of sheet metal or a single mold (etc.), without rivets, screws, or adhesive to hold separately formed pieces together, is an integral (and integrally formed) element. In contrast, an element formed from multiple pieces that are separately formed initially, then later connected together, is not an integral (or integrally formed) element.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to the reference system (e.g., for a building, relative to a plumb vertical line as can generally correspond to the direction of in-wall studs), with a similarly derived meaning for “substantially horizontal” (relative to the horizontal direction, as can generally correspond to the direction that spaces adjacent in-wall studs apart from each other).

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Where specified in particular, “substantially” can indicate a variation in one numerical direction relative to a reference value. For example, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

What is claimed is:

1. A coupler system for rebar, the coupler system comprising:
a rebar coupler that includes a coupler body, the coupler body including a hollow interior, and a first end and a second end that are open to the hollow interior to receive rebar into opposing ends of the hollow interior along a longitudinal axis;
the coupler body defining one or more grout ports that open into the hollow interior, including a first grout port on the first end of the coupler body;
the hollow interior including internal ribs that define cells to engage grout received within the coupler body, the cells including:
a first cell adjacent to the first grout port and defining a first volume to receive grout; and
a second cell adjacent to the first cell and defining a second volume to receive grout,
the first cell being radially wider than the second cell so that the first volume is larger than the second volume.

2. The coupler system of claim 1, wherein a first outer diameter of the coupler body along the first cell is substantially equal to a second outer diameter along the second end of the coupler body.

3. The coupler system of claim 2, wherein a third outer diameter of the coupler body along the second cell is smaller than the second outer diameter.

4. The coupler system of claim 1, wherein a first outer diameter of the coupler body along the first cell is no wider than a second outer diameter along the second end of the coupler body.

5. The coupler system of claim 1, wherein a first rib separates the first cell from the second cell; and
wherein the first grout port is on an opposite side of the first rib from the second cell.

6. The coupler system of claim 1, further comprising:
a stop assembly for prefabricated concrete construction, the stop assembly including:
an anchor; and
a stop body supported by the anchor,
the anchor being secured to a concrete form and engaging the second end of the coupler body to secure the stop assembly to the coupler body, with the stop body supported within the hollow interior of the coupler body to provide a stop for a first length of rebar inserted into the first end of the coupler body.

7. The coupler system of claim 6, wherein the anchor includes a compressible grommet that engages the second end of the coupler body within the hollow interior.

8. The coupler system of claim 6, wherein the stop body includes an enlarged diameter at a free end that provides the stop for the first length of rebar.

9. The coupler system of claim 1, wherein the coupler body further includes:
a hole that receives a locking member into the coupler body to secure a first length of rebar within the hollow interior; and
a set of pads arranged within the hollow interior to collectively align and support rebar engaged by the locking member, the set of pads including:
a first pad spaced longitudinally apart from the hole toward the first end of the coupler body; and
a second pad spaced longitudinally apart from the hole toward the second end of the coupler body.

10. The coupler system of claim 9, wherein the first pad and the second pad are formed as protruding ribs.

11. The coupler system of claim 10, wherein the protruding ribs are elongate along a longitudinal direction substantially parallel with the longitudinal axis.

12. The coupler system of claim 9, wherein top support surfaces of the first and second pads extend non-radially from an inner surface of the coupler body.

13. The coupler system of claim 9, wherein the hole is on the first end of the coupler body and the first pad extends within the second cell.

14. The coupler system of claim 1, wherein the first grout port supports an outlet tube that extends beyond the first end of the coupler body.

15. A coupler system for rebar, the coupler system comprising:
a rebar connection that includes a coupler body with a hollow interior and one or more grout ports that open into the hollow interior, including a first grout port;
the hollow interior defining cells to engage grout received within the coupler body,
the cells including a first cell that defines a first volume to receive grout and a second cell that is adjacent to the first cell and defines a second volume to receive grout,
the first grout port opening into the first cell; and
the first volume being larger than the second volume.

16. The coupler system of claim 15, wherein the first volume is between 50% and 200% larger than the second volume, inclusive.

17. The coupler system of claim 15, further comprising:
a stop assembly for prefabricated concrete construction, the stop assembly including:
an anchor; and
a stop body supported by the anchor;
the anchor being temporarily secured to a concrete form and removably engaging an interior diameter of an end of the coupler body to secure the stop assembly to the coupler body; and
the stop body being supported within the hollow interior of the coupler body to provide a temporary stop for a first length of rebar inserted axially into the coupler body.

18. A method of prefabricating a concrete structure using a coupler system for rebar, the method comprising:
securing a rebar coupler to a concrete form with a stop assembly, so that:
a first end of a coupler body of the rebar coupler extends away from the concrete form;
an anchor of the stop assembly is secured to a concrete form and engages a second end of the coupler body to secure the stop assembly to the coupler body; and
a stop body of the stop assembly is supported within a hollow interior of the coupler body to provide a stop for a first length of rebar within the hollow interior;
inserting a first length of rebar into the hollow interior via the first end of the rebar coupler, until the first length of rebar contacts the stop body;
pouring and curing concrete around the first length of rebar and the rebar coupler; and
removing the stop assembly and the concrete form from the rebar coupler and the cured concrete.

19. The method of claim 18, further comprising:
after inserting the first length of rebar into the hollow interior and before pouring and curing the concrete, advancing a locking member through a hole in the coupler body to secure the first length of rebar within the hollow interior against a set of pads arranged within the hollow interior, the set of pads including:
a first pad spaced longitudinally apart from the hole toward the first end of the coupler body; and
a second pad spaced longitudinally apart from the hole toward the second end of the coupler body.

20. The method of claim 19, further comprising:
after removing the stop assembly and the concrete form, inserting a second length of rebar into the hollow interior via the second end of the coupler body; and
introducing grout into the hollow interior to surround the first and second lengths of rebar, including introducing grout into a first cell that defines a first volume to receive the grout and a second cell that is adjacent to the first cell and defines a second volume to receive the grout, with a first grout port of the coupler body opening into the first cell and the first volume being at least 50% larger than the second volume.
